(19) United States
(12) Patent Application Publication
(10) Pub. No.: US 2025/0064169 A1
(43) Pub. Date: Feb. 27, 2025

(54) METHODS AND APPARATUSES FOR DESIGNING FOOTWEAR

(71) Applicant: Materialise Motion N.V., Beringen (BE)

(72) Inventors: Dries VANDECRUYS, Leuven (BE); Fien BURG, Beringen (BE); Sander VAN NIEUWENHOVEN, Beringen (BE)

(21) Appl. No.: 18/941,297

(22) Filed: Nov. 8, 2024

Related U.S. Application Data
(63) Continuation of application No. PCT/US2023/021236, filed on May 5, 2023.
(60) Provisional application No. 63/364,392, filed on May 9, 2022.

(51) Int. Cl. A43B 13/18; A43B 3/00; A43D 1/02

(52) U.S. Cl. CPC A43B 13/186; A43B 3/0036; A43D 1/025

(57) ABSTRACT

A custom footwear article and method for manufacturing the custom footwear article is disclosed. In some examples, the custom footwear article includes at least one corrective feature configured to stimulate a foot of a user to move and roll in accordance with a pattern. In some examples, the custom footwear article includes a sole, an insole, a midsole, an outsole, an upper, or any part thereof. In some examples, the method includes acquiring footwear-specific data. In some examples, the method includes acquiring user-specific data. In some examples, the method includes generating a model of a custom footwear article based on the acquired footwear-specific data and the user-specific data. In some examples, the method includes manufacturing the custom footwear article based on the model.

### CROSS-REFERENCE TO RELATED APPLICATIONS

This application is a continuation of International Application No. PCT/US2023/021236, filed on May 5, 2023, which claims the benefit of and priority to U.S. Provisional Application Ser. No. 63/364,392 filed May 9, 2022, the entire disclosures of both of which are hereby incorporated by reference.

### BACKGROUND

This application relates to the field of footwear, in particular to custom footwear designs, and methods and apparatuses for designing custom footwear.

This application relates to the field of footwear, in particular to custom footwear designs, and methods and apparatuses for designing custom footwear.

Traditional footwear is not customized for a user. Rather, the footwear is designed based on general characteristics that apply to most feet, most of the time. As a result, footwear is often not comfortable to users and/or not capable of correcting or preventing problematic foot-related conditions.

Footwear inserts (e.g. insoles) have been used in an effort to correct various issues related to the foot. Unfortunately, in most cases, the footwear inserts are no more suited to a user's foot than the original footwear. Consequently, “custom” footwear inserts have been developed in order to try and correct or prevent issues while taking into account, to some extent at least, a user's actual foot.

The design of custom footwear inserts is often a manual, time-consuming, error-prone, and expensive operation. As such, large-scale manufacturing of such custom footwear inserts has been problematic since, by definition, each footwear insert is custom. These factors and others have limited the availability and effectiveness of custom footwear and increased their cost.

Footwear and component parts of footwear may be configured to serve diverse functions ranging from protection and support of a user's foot to correction of a user's gait and posture to providing comfort to the user. Inner footwear components such as insoles, which directly contact the sole of user's foot, mediate many of these functions. Current insole technologies are quickly evolving, and new insole designs incorporate new materials and new structural features, as well as custom features for specific users. Nonetheless, a few core traits such as flexibility and durability remain common to all insoles. Flexibility in the insole ensures that the insole bends with the movement of the user's foot, for example, to permit the user's toes to bend to a full degree of flexion during the gait cycle. Durability of the insole ensures that the insole will continue to perform its functions over time without breaking or losing its shape. In addition, ventilation is an important trait in insoles, especially for insoles that will be worn over long periods and/or used intensively.

In general, adequate ventilation contributes to comfort, performance, and long-term usability of footwear. Footwear used for sports, in particular, may have unique requirements for ventilation due to the specialized shape and function of footwear designed for specific sports. In some footwear designs, ventilation comes from air holes and/or breathable regions built in the upper of the shoes, such as mesh fabric in the toe area of running shoes. Other footwear designs incorporate ventilation elements in the sole of the footwear. In cycling shoes, indentations that traverse diagonally in the sole of the shoes may be used to optimize aerodynamics in addition to allowing air flow for ventilation. Still other designs feature inlet and outlet channels through which air is pushed when the user takes a step.

Many of these current solutions for ventilation are incorporated into the footwear design, which limits the versatility of these solutions for different types of footwear. One approach is to use removable insoles, where the insoles serve other functions like providing support, cushioning, or shock absorption, and additionally have vents that promote air circulation. However, when vents are added to insoles designed for other purposes, the ventilation is a secondary consideration and may not be optimal. Moreover, the position of the vents will not be suited for all designs, types, or brands of footwear. In cycling shoes, for example, the vents in the insole should ideally match the position of any vents built into the cycling shoes, but each manufacturer has their own unique shoe designs with specific vents. Finally, many of the current insoles are stiff and thick, which may impair the user's movement in some directions, and further limit the types of shoes for which the insoles are suitable.

Accordingly, what is needed are improved designs for footwear and footwear portions, that improve the fit for a user and are capable of being manufactured efficiently and cost-effectively, and methods and apparatuses for designing and manufacturing custom footwear.

### SUMMARY

In one embodiment, a custom footwear article is disclosed. In some examples, the custom footwear article includes at least one corrective feature configured to stimulate a foot of a user to move and roll in accordance with a pattern. In some examples, the custom footwear article includes a sole, an insole, a midsole, an outsole, an upper, or any part thereof.

In one embodiment, a method for manufacturing a custom footwear article is disclosed. In some examples, the method includes acquiring footwear-specific data. In some examples, the method includes acquiring user-specific data. In some examples, the method includes generating a model of a custom footwear article based on the acquired footwear-specific data and the user-specific data. In some examples, the method includes manufacturing the custom footwear article based on the model.

Further embodiments include one or more non-transitory computer-readable storage media comprising instructions that when executed by one or more processors of a computer system cause a computer system to carry out the above methods, as well as a computer system comprising one or more memories and one or more processors configured to carry out the above methods.

### BRIEF DESCRIPTION OF THE DRAWINGS

FIG. 1 depicts an embodiment of custom footwear article including an insole.

FIG. 2A depicts a view of an embodiment of components of a base layer of the insole of FIG. 1.

FIG. 2B depicts a view of an embodiment of components of a base layer of the insole of FIG. 1.

FIG. 2C depicts a view of an embodiment of a base layer of the insole of FIG. 1.

FIG. 2D depicts a view of an embodiment of a base layer of the insole of FIG. 1.

FIG. 3 depicts a view of embodiments of a directional stiffness layer of the insole of FIG. 1.

FIG. 4 depicts a posterior view and a lateral view of embodiments of a stability layer of the insole of FIG. 1.

FIG. 5 depicts a posterior view and a lateral view of embodiments of a stability layer of the insole of FIG. 1.

FIG. 6 depicts a view of embodiments of a stability layer of the insole of FIG. 1.

FIG. 7 depicts a view of an embodiment of a reinforcement layer of the insole of FIG. 1.

FIGS. 8A-8C depict an example of a forefoot support. FIG. 8A depicts a perspective view of a top surface of an example insole of a custom footwear article including a forefoot support, showing the anterior-posterior (AP) and medial-lateral (ML) axes.

FIG. 8B depicts a top view of the forefoot support of the example insole of FIG. 8A.

FIG. 8C depicts a view of the bottom surface of the example insole of FIG. 8A.

FIG. 9A depicts a view of a forefoot support from a bottom surface of an example insole of a custom footwear article.

FIG. 9B depicts a view of flexibility of a forefoot support from a bottom surface of the example insole of FIG. 9A.

FIG. 10A depicts a bottom surface of an example forefoot support of a custom footwear article.

FIG. 10B depicts a bottom surface of an example forefoot support of a custom footwear article relative to an inner side of a user forefoot.

FIG. 11 is a flowchart of an example process for manufacturing a custom footwear article.

FIG. 12A depicts a plot of center of pressure (COP) points at individual time points during a user roll-off.

FIG. 12B depicts a plot of COP points at individual time points during another user roll-off.

FIG. 13 depicts an underside of a custom footwear article including a contour.

FIG. 14 depicts a bottom view of a custom footwear article in which a stability layer includes a surface texture.

FIG. 15 depicts an embodiment of a custom-footwear system.

FIG. 16A depicts a side view of an example of a corrective feature added to a custom footwear article.

FIG. 16B depicts a bottom view of an example of a corrective feature added to a custom footwear article.

FIG. 17A depicts a pressure measurement for a user and a corresponding COP curve for the user.

FIG. 17B depicts a pressure measurement for another user and a corresponding COP curve for the another user.

### DETAILED DESCRIPTION OF THE DISCLOSURE

Unless otherwise mentioned, the term “user” herein refers to the user or prospective user of the custom footwear or custom footwear portion. The term “operator” herein refers to the person executing the methods or method steps described herein, or operating the systems described herein. Unless otherwise mentioned, the operator may be a medical professional, a non-medical professional, such as a technician, engineer, or a trained store employee, or a member of the general public.

The present disclosure relates to improved designs for footwear and footwear portions, and methods and apparatuses for designing custom footwear, and in particular, custom footwear portions. The term “custom footwear” or “custom footwear portion” herein refers to one or more items of footwear or a footwear portion, respectively, that have been specifically designed for a particular user.

Custom footwear may be beneficial for the treatment of a variety of known conditions related to the foot. For example, pronation in the foot (i.e. inward roll of the foot while standing, walking and running) may lead to swelling and Achilles tendon issues. To treat the pronation, custom footwear may be designed to correct or improve the static and dynamic pressures on the foot. For example, the custom footwear may correct support under the medial arch of the foot, and may reduce the ability of the footwear to bend in certain directions.

As another example, a bunion may be treated with custom footwear that reduces medial load and provides customized support for the hallux (i.e. big toe). Other conditions may also be treated using custom footwear, such as: Achilles tendinitis, Achilles tendinopathy, ankle instability, arthritis, bunion, calcaneal apophysitis (Sever's disease), Charcot foot, chondromalacia patella, diabetic neuropathy, fibromatosis plantaris, functional hallux limitus, Haglund's deformity, hallux abducto valgus, hallux limitus/rigidus, heel fat pad atrophy, heel spur, iliotibial friction syndrome, lateral, medial or tibial knee pain, leg length difference, medial tibial stress syndrome, metatarsalgia, Morton's neuralgia, Morton's toe, osteoarthritis, patella tendinopathy, patellofemoral knee pain, peroneus tendinopathy, pes cavus, pes planus/plano valgus, plantar fasciitis, poor circulation, posterior tibial tendon dysfunction, pronation of the foot, repetitive strain injuries, rheumatoid arthritis, scoliosis, sesamoiditis, shin splints, sinus tarsi, tarsal tunnel syndrome, and others as are known by persons of skill in the art.

In addition to treating existing, adverse foot conditions, custom footwear may also help to postpone or prevent pain, injuries and the onset of foot conditions. For example, custom footwear may reduce stress-related pain and injuries to the foot, ankle, leg, knee, back, etc. by better distributing the weight during the impact of footfalls, or by altering the way a foot falls and rotates during dynamic movements. Similarly, custom footwear may prevent movement in certain directions (such as rolling ankle movement) while promoting movement in other directions (such as rolling of the forefoot during transitional movements.

Moreover, custom footwear may improve biomechanical performance (e.g. for athletes) during activities such as walking, jogging, running, jumping, cycling, dancing, ballet, tennis, basketball, soccer, fitness and training, skateboard, golf, athletics, hiking, volleyball, padel or rock climbing. For example, custom footwear may alter the angle of impact of a foot during dynamic activities such as running, which may in turn increase the overall speed of the runner. Many other benefits of custom footwear exist, as are known by persons of skill in the art.

Custom footwear may be designed using data regarding a particular user's physical characteristics or attributes, so-called “static” user-specific data. For example, a user's foot size and static foot pressure (e.g. when standing) may be measured.

Custom footwear may also be designed using dynamic user-specific data, such as dynamic foot pressure measurements. For example, the dynamic pressures on a user's foot may be measured during dynamic foot activities, such as: running, walking, jumping, landing, pivoting, rolling, rocking, etc. Virtually any functional biomechanical measurements may be used during the design of custom footwear.

### Static User-Specific Data

An aspect of the present disclosure relates to static user data that may be used in the design of custom footwear, and means to collect such data.

Static user-specific data may be used in the design of custom footwear. Different types of static user-specific data can be generated, determined or measured by different methods. Static user-specific data may comprise individual numerical values, binary values, text values, selections from enumerated lists, two-dimensional (2D) or three-dimensional (3D) geometric or graphical data, such as photographs, pixelated images, vector-based images, medical images, medical image sets, voxel-based 3D models, 3D surface models and the like. In some instances, static user-specific data may be gathered using forms or questionnaires, on paper or in digital form. In other instances, measurement instruments or systems may be employed.

For example, basic user data such as: gender, height, and weight may be used for the design of custom footwear.

Some user data may be objective data (e.g. height and weight), while other user data may be subjective (e.g. activity level and user preferences).

Static user-specific data may be body-part-specific. For example, data related to a particular user's foot may include: side (left, right or both), foot length, foot width, arch height, arch location, foot shape, footprint, shoe size, maximum flexion or extension of the foot in various directions, flexion or extension of the foot in rest, maximum inversion and eversion of the foot, inversion and eversion of the foot in rest, maximum pronation and supination of the foot, pronation or supination of the foot in rest, shapes and locations of certain bones and bone structures, locations, trajectories, lengths and attachment points of certain muscles, ligaments and tendons, presence, shape and condition of menisci, presence, location, shape, thickness and condition of cartilage, presence, location and shape of osteophytes and other characteristics as are known by persons of skill in the art. In some instances, static user-specific data may comprise a description of symptoms, a medical condition or a desired treatment. In some instances, the static user-specific data may comprise a medical report or a prescription. In some instances, physical characteristics may be determined using manual physical measurement instruments (e.g. a measuring tape), while others may be determined by digital measurement systems (e.g. a digital scale).

Given the complexity of the shape and composition of various body parts, such as the foot, more precise data-capture methods may be advantageous.

For example, static user-specific data may be generated using one or more image sensors, such as live or still cameras. Various types of cameras can be used, including: traditional digital cameras with a single image sensor or stereoscopic cameras with two or more image sensors. Traditional digital cameras, including mobile device cameras, may be used by taking a plurality of images of an object, such as a body part, from different angles in order to infer depth and 3D structure. The plurality of images of the body part, such as a foot (or other anatomical features such as the ankle, calf, etc.), may be analyzed by, for example, a computer system, in order to determine three-dimensional (3D), user-specific data, such as a 3D model, using techniques such as photogrammetric mapping or reflected structured light. For example, U.S. Pat. No. 8,126,261, entitled “3D Face Reconstruction from 2D Images”, which is incorporated by reference in its entirety herein, discloses methods for determining 3D models of, e.g., a face, from a plurality of two-dimensional (2D) images. Likewise, PCT Patent Publication WO 2012/129252, entitled “Digital 3D Camera Using Periodic Illumination,” which is incorporated by reference in its entirety herein, discloses methods of using a digital camera and projected light patterns to determine 3D models using 2D image data.

Additionally, two or more cameras may be used simultaneously to generate 3D user-specific data. For example, U.S. Pat. No. 8,532,368, entitled “Method and Apparatus for Producing 3D Model of An Environment,” which is incorporated herein by reference in its entirety, describes methods of using a mobile stereo camera system to determine 3D models. Accordingly, image sensors may be used with the aforementioned methods and others as are known in the art in order to capture 2D user-specific data and to build user-specific 3D models based on the 2D data.

In some cases, mobile devices (e.g. smartphones and tablets) may include stereoscopic image sensors, which may be referred to as “3D cameras”. Such devices may have the ability to capture image data and create 3D data or a 3D model without the need for additional processing by an independent processing system.

Additionally, more advanced camera systems, such as the “Kinect”, available from Microsoft Corporation (Redmond, Washington, USA) provide image data including depth information. Similarly, purpose-built 3D scanners using image sensors, like the “Gotcha” 3Dscanner of 4D Dynamics (Antwerp, Belgium) or MakerBot® Digitizer™ (New York, New York, USA) may be used.

An advantage of using an image-sensor-based device, such as one or more cameras or camera systems as described above, for determining user-specific data is that such devices are typically digital, portable, and relatively inexpensive. As such, systems for designing custom footwear may be wholly or partially (e.g. the imaging system) portable. Portability of the system increases the ability to use such a system in different contexts.

With any of the aforementioned image-sensor-based devices, it may be beneficial to include in some or all of the 2D or 3D image data an object of known size, such as a ruler, a credit card or any other device of which one or more dimensions are known. The inclusion of such an object may allow a more accurate determination of the scale of the other objects in the 2D image data, such as the user's body part. For example, the user may be asked to stand on a plate with known calibration marks while the image data is being captured. As an alternative example, the user may be asked to stand on a flat surface next to a chip card or magnetic-strip card of a standard size (e.g. with dimensions according to the ID-1 standard defined in ISO 7810) while the image data is being captured. Such cards are widely available to the general public (e.g. in the form of personal identification cards, driving licenses, payment cards, fare-collection cards for public transport or retail loyalty cards) and have a convenient size for serving as a scaling element for body parts.

Other devices may be used to generate 3D static user-specific data. For example, mechanical scanning systems, optical scanners, laser-based scanners, and other scanning systems as are known by persons of skill in the art may be used to scan a body part, such as a foot, and to create a 3D model associated with the scanned body part. An advantage of, for example, laser-based or optical scanning systems is that they may create very accurate 3D models of the object being scanned. However, such scanning systems may be less portable and more costly than an image-sensor-based device, such as those described above. In some instances, dedicated scanning systems may be used that are configured for a particular type of body part. For example, dedicated foot-scanning systems are known in the art, which typically comprise a linear scanning element mounted on a movable arm below a glass plate (a plantar scanning element). The user may be asked to stand on the glass plate while the movable arm with the linear scanning element passes below the foot. In this way a 3D model of the underside of the user's foot—e.g., in load-bearing condition—can be generated. Some such foot-scanning systems further may comprise scanning elements for scanning the upper side of the foot. Such scanning systems are capable of generating a 3D model of the entire foot.

Medical imaging techniques may also be used to generate 2D and 3D static user-specific data. For example, X-ray scans, computed tomography (CT) scans, positron emission tomography (PET) scans, magnetic resonance imaging (MRI), ultrasound scans, and other medical imaging techniques as known by those of skill in the art may be used to create 2D and 3D user-specific data, which may, in turn, be used to create a 2D or 3D model, such as a 3D surface model, of a body part, such as a foot. The process of generating a 2D or 3D model from one or more medical images is generally referred to as “segmentation”, and can be performed on a computing device using, e.g., the software Mimics® (Materialise NV, Belgium). Segmenting one or more medical images may be done fully automatically, semi-automatically or may require operator input, e.g., for finetuning the result of an initial automatic segmentation step. In particular, certain types of medical imaging modalities may also provide additional detail regarding internal anatomical features and functions, such as bone structures, bone alignment, locations, trajectories, lengths and attachment points of certain muscles, ligaments and tendons, presence, shape and condition of menisci, presence, location, shape, thickness and condition of cartilage, presence, location and shape of osteophytes, and others as are known in the art. The design of custom footwear may beneficially account for such features.

Other types of sensors may also be used to determine static user-specific data. For example, a pressure-sensitive pad may record the distribution of pressures associated with a user's footprint. That is, a user may stand on a pressure-sensitive pad in order to generate a plurality of pressure readings associated with the user's static footprint.

In some instances, pressure sensors may be user wearable. For example, pressure sensors may take the form of insole sensors, i.e. thin pressure-sensitive pads shaped so as to be inserted into an item of footwear subsequently worn by the user. Such user-wearable pressure sensors may record the distribution of pressures not only associated with a user's footprint, but specifically the distribution of pressures manifested as the user is wearing the item of footwear for which a custom footwear portion is to be designed. Such insole sensors may be provided in a range of shoe sizes, and may be pliant, so as to adapt to the shape of the item of footwear. Such insole sensors may also be custom fabricated to be compatible with a particular item of footwear, for example based on footwear-specific data as described below. User-wearable pressure sensors may comprise a data-storage component for storing the measured data. Alternatively, they may comprise a communication interface for transferring the measured data to an external data-storage system. The communication interface may be a wired communication interface, in which case the external data-storage system may advantageously be worn on the user's body. The communication interface may also be a wireless communication interface, in which case the external data-storage system may be independent of the user.

In some instances, various forms of measurement, imaging and sensing may be performed on a positive or negative cast, mold, or other impression of a user's body part, such as a foot mold. This capability allows for the design of custom footwear without the need for a user to be co-located with, for example, the scanning equipment. In other instances, a user may generate data, such as 2D or 3D image data, using his or her own equipment, such as a camera-equipped mobile phone or video camera, and then provide that data to a data-processing system meant to design custom footwear for that user. In this way, the user need not be co-located with other aspects of a custom-footwear design system. For example, the user may provide basic user data (e.g. height, weight, and preference data) along with a plurality of self-generated 2D image data to a remote service that uses the data to design and manufacture custom footwear for that user. As described above, it may be beneficial to include in one or more 2D images an object of known size to allow for an accurate determination of the scale of the other objects in the 2D image data, such as the user's body part.

Generally speaking, the aforementioned methods of generating static user-specific data may be used to create detailed 2D or 3D models of a user's body part, such as a foot. Those models may, in turn, be used to design custom footwear for the user. To that end, computer-aided design (CAD) or computer-aided manufacturing (CAM) software, such as software commercially available from Materialise USA (Plymouth, Michigan, USA) may be used to process the user-specific data and to create custom footwear designs.

### Dynamic User-Specific Data

A further aspect of the present disclosure relates to dynamic user data that may be used in the design of custom footwear, and means to collect such data.

Custom footwear may also be designed using dynamic user-specific data. Dynamic user-specific data may include data collected regarding dynamic user movements, such as: running, jogging, walking, jumping, landing, pivoting, rolling, rocking, etc.

One means of measuring dynamic user-specific data may be a pressure-sensitive mat or pad that may be configured to measure pressure data over time and to provide that data to, for example, a processing system. Such pressure-sensitive pads may be relatively large, such that, in one measurement session, they can measure more than one foot during user movements and/or multiple movement cycles of the same foot. For example, a pressure-sensitive mat or pad with a length and width between 30 cm and 80 cm, e.g. 50 cm×50 cm, may, within one measurement session, measure the pressure distribution over both feet as it changes over time while the user jumps on it from standstill and subsequently lands on it. As another example, an elongated pressure-sensitive mat or pad with a width between 30 cm and 80 cm, e.g. 50 cm, and a length of several meters, e.g. 2 m or 3 m, may measure the pressure distribution over both feet as it changes over time during one or more strides while the user walks or runs over it. Having a pressure-sensitive mat or pad of sufficient size makes it easier to make foot contact with the mat or pad during user movements, and therefore reduces or eliminates the need for the user to adapt his stride and focus on making contact with the mat or pad. This may allow for a measurement that is more representative for the user's natural, uninhibited way of moving. Moreover, registering multiple strides within one measurement session (e.g. within one continuous user movement across the mat or pad) allows for averaging between the measurement data of corresponding time points across multiple strides so as to reduce or eliminate noise or measurement artefacts. Additionally, pressure-sensitive pads of sufficient size may be able to measure characteristics such as: stride, gait, alignment, footfall, foot rotation, and others as are known by persons of skill in the art. For certain dynamic user movements, such as walking and in particular jogging and running, it may be beneficial to provide sufficient space on either end of the pressure-sensitive mat or pad, so as to allow the user to accelerate and settle into a natural stride at a natural speed before making foot contact with the pressure-sensitive mat or pad, to maintain said speed and natural stride along the full length of the pressure-sensitive mat or pad and to decelerate only after leaving the pressure-sensitive mat or pad. For walking, a space of 1-2 m at either end should suffice. For movements at higher speed, such as jogging and running, more space, e.g. between 2 m and 6 m, more particularly 3 m, 4 m or 5 m, is to be preferred.

Systems that measure the dynamic pressure distribution on a foot are described, for example, in European patent applications EP0970657A1 and EP1127541A1, each of which is incorporated by reference in its entirety. Based on the measurement of dynamic pressures on a foot during movement, assumptions can be made about the movement of various parts of the foot. Ultimately, custom footwear may be designed based on the dynamic pressure measurements.

Another means of measuring dynamic user-specific data is a user-wearable pressure sensor, such as described above.

Other dynamic-data-capture devices exist, such as user-wearable accelerometers, user-wearable force sensors, motion-capture sensors, image sensors, and the like. User-wearable accelerometers can be found, for example, in the form of activity trackers or smartwatches. They may capture a user's activity level, walking or running speed, or other aspects of a user's movement patterns. Force sensors, for example, may be attached to a user to measure force as the user moves dynamically. In some instances, mobile devices including motion-sensitive sensors may be used to gather motion data to be analyzed. Thus, as described above, a user may use his or her own mobile device not only to capture static user data (such basic user data and still images), but also to capture dynamic user data, such as force and motion data. In some instances, a user may collect all the data used for a custom footwear design using his or her own mobile device.

Motion-capture systems may be used to capture and analyze dynamic user data. For example, systems using computer-identifiable targets attached to a user and a monitoring system may track the targets in order to generate dynamic user data, such as gait.

Dynamic data measurements may be combined. For example, pressure-sensitive pads and/or motion sensors may be used alongside video-capture equipment so that the dynamic data can be compared with video footage of a user in action. For example, a high-speed camera may record the movement of a user's body part, such as a foot, while pressure-sensitive sensors capture data regarding the foot's movement, impacts, etc.

### Statistical Body-Part Data

A further aspect of the present disclosure relates to statistical data that may be used in the design of custom footwear, and ways of using such data.

Custom footwear may also be designed using statistical data, such as statistical body-part data such as population data. Statistical data may be used to supplement user-specific data in different ways. For example, a particular size of shoe may be associated with several characteristics that are statistically predictable based on analyzing population data. As mentioned above, a particular size of shoe may be associated with statistical averages and distributions regarding the length and width of a foot of that size, as well as placement, shapes and dimensions of various anatomical features, such as toes, heel, arch, etc. for a foot of that size. Statistical data may also relate to other user characteristics, such as body weight, age, activity level, gender, ethnicity, etc. Statistical data may relate to averages, distributions, standard deviations, variances and correlations of and between any of these measures, values or attributes.

In some instances, a statistical model, such as an active shape model (ASM), a statistical shape model (SSM), or an active appearance model (AAM), may be constructed based on a plurality of user-specific 2D or 3D body-part data from different members of a population, i.e. the training set. Statistical models may be deformable models or templates in which the deformations are restricted to a limited number of modes, each controlled by a coefficient comprised in a coefficient vector, so as to reflect the statistical correlations between shape variations found among the training set. Assigning values to the coefficients in the coefficient vector may result in a particular deformation of the statistical model, also called an instance. A statistical model may be constructed for a broad population, or more specific statistical models may be constructed for more specific populations. For example, separate statistical models may be constructed for different genders, different ethnic groups, different shoe sizes, or combinations thereof.

In some instances, statistical models can be used, for example, to analyze the shape of a user's body part. For example, an SSM may be fitted onto a 2D or 3D model of a user's body part—the instance of the SSM of which the shape best matches a 2D or 3D shape of the 2D or 3D model of the user's body part may be determined—by determining appropriate values for the SSM's coefficients, using any fitting strategy known in the art. The resulting coefficient values may teach to what extent the user's body part diverges from the average. Statistical models constructed based on sufficiently large training sets, e.g., several thousands of data sets, may offer the possibility of identifying certain clusters, e.g., sub-groups of the population concentrated around particular values for one or more coefficients. If the training set comprises, next to 2D or 3D body-part data, information regarding pathologies, conditions, risks of developing certain conditions, risks of certain injuries, such as stress-related injuries, such clusters may be linked to said information for diagnostic purposes or disease scoring. An analysis of the coefficient values of a statistical model, such as an SSM, fitted onto a 2D or 3D model of a specific user's body part may then help diagnose the specific user with a certain condition, assess the specific user's risk of developing a certain condition, or assess the specific user's risk of certain injuries, e.g., by assigning the specific user a score or a class. Any suitable analytical techniques, in particular statistical methods and machine-learning techniques, known in the art may be employed.

In some instances, statistical models, such as SSMs, may be used to create a 2D or 3D model of the user's body part in order to design custom footwear. Such statistical shape models may be particularly useful where the only user-specific data available is sparse, incomplete or inaccurate. An SSM may then be fitted to such incomplete user-specific data, and the resulting instance of the SSM may provide a “best-guess” approximation of the shape of the user's body part and thus a 3D model of the user's body part. For example, a 3D SSM of a body part may be fitted to a sparse set of data points, e.g., one or more surface contours or a low-resolution 3D scan of the specific user's body part, to produce a higher-resolution 3D model of the user's body part. As a particular example, a 3D SSM of a foot may be fitted to a 3D scan of only the underside of the user's foot, e.g., a 3D scan taken with a foot-scanning system comprising solely a plantar scanning element. The resulting instance then may provide a “best guess” approximation of the shape of the entire foot. Similarly, a 3D SSM of a foot may be fitted to a 2D outline of the user's foot sole, e.g., by determining the coefficient vector of the SSM instance whose projection onto a plane best matches the given 2D outline. The resulting instance of the SSM may provide a “best-guess” approximation of the shape of the user's foot, and may therefore be used as a user-specific 3D model of the foot.

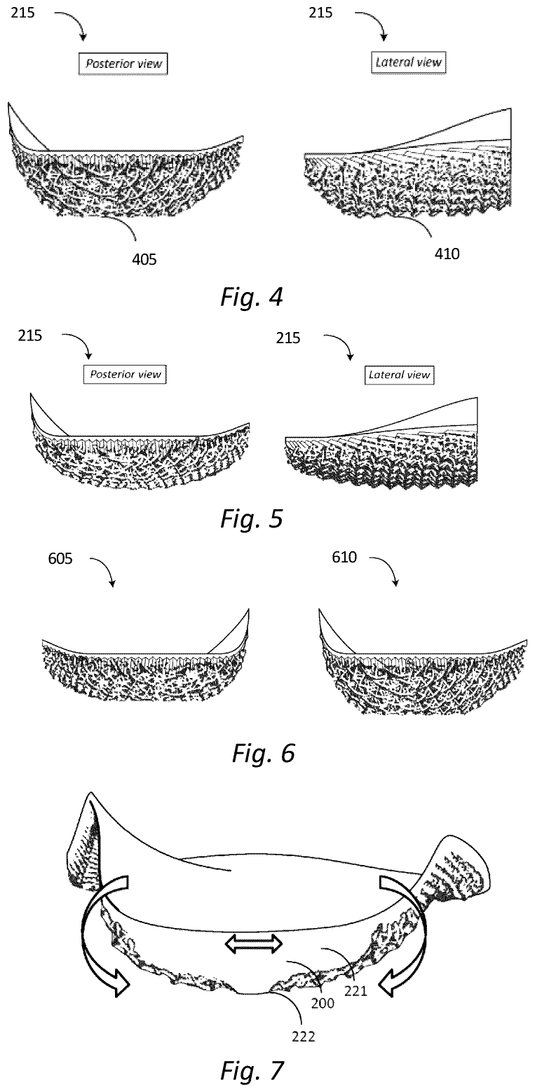

In some instances, multiple statistical models of which a correspondence is known may be used to create a 3D model of the user's body part based on different types of data. For example, international patent application PCT/EP2015/050134 discloses a method of predicting the shape of an object based on the relationship between shape models and is incorporated herein in its entirety. The methods illustrated in FIGS. 4A-4B and elaborated in the corresponding sections of said publication may be applied to the generation of user-specific 3D models. For example, starting from a first training set of 2D outlines of foot soles of a plurality of individuals forming a sample from a population, and a second training set of 3D models of the corresponding feet of the same individuals, two statistical models, such as statistical shape models, may be generated, one for each training set. Further, based on the correspondence between the members of both training sets, a relationship between the two statistical models may be established. If a 2D outline of a specific user's foot sole is available, the first statistical model may be fitted on said user-specific 2D outline resulting in a user-specific instance of the first statistical model. The coefficient vector of this instance of the first statistical model, combined with the known relationship between the first and second statistical models, may then be used to generate an instance of the second statistical model, e.g. a 3D model, such as a 3D surface model, which may serve as an approximation of the 3D shape of the user's foot. A similar method may be used to generate a 3D model of the user's foot based on a 2D foot-sole scan, starting from a training set of 2D foot-sole scans and corresponding 3D models of feet. Such a process is beneficial, as it may eliminate the need for image-sensor-based systems, laser-based scanning systems or optical scanning systems if a 2D foot scanner is available. A similar method may be used to generate a 3D model of the user's foot based on a static pressure measurement, starting from a training set of static pressure measurements and corresponding 3D models of feet. Such a process if beneficial, as it may eliminate the need for image-sensor-based systems, laser-based scanning systems or optical scanning systems if a pressure sensor is available. The described methods may further eliminate the need for method steps related to the gathering of data using those image-sensor-based systems, laser-based scanning systems or optical scanning systems, resulting in an efficiency gain. Finally, they may eliminate the transfer of such data between the different components of the systems described herein, leading to further efficiency gains.

Additionally, a statistical model of a body part, such as a foot, may be used to provide automated analysis of 2D or 3D image data of that body part. For example, statistical models may be used to recognize a body part, or sub-parts of the body part in a 2D image, such as a photograph or a static pressure measurement, of the body part. More particularly, a statistical model of the foot, such as an AAM, may be used to automatically identify in a pressure measurement of the user's foot the individual areas of the foot sole, such as the toes, the forefoot, or the heel. Similarly, statistical models may be used to recognize a body part, or sub-parts of the body part in 3D image data, such as a medical image set (e.g., a CT scan, an MRI scan, or any medical image data produced by the medical imaging techniques described above), of the body part. More particularly, a statistical model of the foot and/or of anatomical structures in the foot (e.g. bones, tendons, ligaments, cartilage regions) may be used to automatically segment the 3D image data, i.e. to automatically identify within the 3D image data those areas representing the foot and/or said anatomical structures with the purpose of subsequently generating one or more 3D models of the identified areas, or to automatically initialize a segmentation for further manual refinement. Techniques that may be utilized for such analyses may be found in: Cootes, T. F.; Edwards, G. J.; Taylor, C. J. (1998). “Active appearance models”. Computer Vision—ECCV'98. Lecture Notes in Computer Science. 1407. p. 484, or Mitchell, S. C.; Bosch, J. G.; Lelieveldt, B. P. F.; van der Geest, R. J.; Reiber, J. H. C. and Sonka, M. (2002). “3-d active appearance models: Segmentation of cardiac MR and ultrasound images”. IEEE Trans. Med. Imaging, 21 (9): 1167-1178.

Statistical shape models are only one example of statistical models. Various other techniques in the field of artificial intelligence, machine learning, supervised learning, unsupervised learning, reinforcement learning, self learning, feature learning, anomaly detection, deep learning and the like are known in the art that can be used to perform the tasks described above, such as supplementing (incomplete) user-specific data, analyzing the shape of a user's body part, creating 2D or 3D models or analyzing 2D or 3D image data.

### Footwear-Specific Data

A further aspect of the present disclosure relates to footwear-specific data that may be used in the design of custom footwear, and means to collect such data.

Custom footwear may also be designed based on data specific to an item of footwear or a footwear portion. For example, a footwear portion may be designed to be compatible with an item of footwear (e.g., an insole may be designed to fit into a specific shoe or model of shoe). As another example, custom footwear may be designed to mimic certain characteristics of another item of footwear or footwear portion.

In some instances, footwear-specific data may relate to a type or size of footwear item or footwear portion. For example, the footwear-specific data may comprise a descriptor for a type of footwear item or footwear portion, as described below, a brand name, a product name, an article number, a shoe size or any combination thereof.

In some instances, footwear-specific data may relate to one or more dimensions of a footwear item or footwear portion. For example, the footwear-specific data may comprise a length, a width, such as a maximum width of a midfoot section or a width of a heel section, or a height, such as a height of a heel counter, a heel cup or an upper, or a height difference between a midfoot and a hindfoot section of an insole. In some instances, these dimensions may be acquired by means of manual measurements, e.g., using a ruler, tape measure, calipers or the like. In some instances, such dimensions may be derived from 2D or 3D shape data, as described below.

In some instances, footwear-specific data may relate to a 3D shape of the footwear item, the footwear portion or any part thereof. For example, the footwear-specific data may comprise 3D data representing the external shape of a footwear portion or an item of footwear. Such 3D data may be acquired by means of any of the 3D data acquisition techniques described above, such as image-sensor-based systems, mechanical scanning systems, optical scanners or laser-based scanners. Additionally or alternatively, the footwear-specific data may comprise 3D data representing the internal shape of an item of footwear, e.g. the shape of any cavity, in particular the cavity configured to receive the user's foot. This may be particularly useful for designing a custom insole, for example. Such 3D data of the internal shape of an item of footwear may, for example, be obtained by means of an optical or laser-based scanning system with a handheld probe. The probe may be inserted into the cavity of the item of footwear, and the scan may be performed in one or more movements along the length of the cavity, possibly with a rotation of the probe between consecutive movements. Several intra-oral scanning devices are known in the art for acquiring 3D scans of a patient's oral cavity. Most utilize one or more optical elements, such as lenses, prisms or mirrors, to project structured light from a light source housed in a handheld probe through a narrower section of the probe, which is sized to fit into the oral cavity, onto the surfaces of the oral cavity. Reflected light is then captured and channeled back through the narrower section onto an optical sensor, also housed in the handheld probe. Similar technology may be employed to scan the internal cavity of an item of footwear. However, whereas intra-oral scanners generally comprise a straight, elongate handheld probe, and operate with a relatively narrow field of view so as to obtain sub- 1/10^{th} mm accuracy, a scanner for footwear may offer greater case of use with a bent or angled handheld probe—for easier access into the footwear item's cavity—and a greater field of view—for obtaining a full scan in fewer scanning movements. Its optical elements may be configured accordingly. The greater field of view may result in a lower accuracy, but 1/10^{th} mm accuracy up to 1 mm accuracy may still suffice for the purpose of designing custom footwear. Alternatively, the probe may comprise multiple optical sensors and/or multiple light sources so as to still obtain sub- 1/10^{th} mm accuracy. As an alternative to using a cavity scanner, 3D data of the internal shape of an item of footwear may also be obtained from a mold of the cavity, such as a last. The 3D data of the mold may be acquired by means of any of the 3D data acquisition techniques described above, such as image-sensor-based systems, mechanical scanning systems, optical scanners or laser-based scanners. In some instances, footwear-specific data may relate to a shape of only a part or feature of an item of footwear or footwear portion. For example, the footwear-specific data may comprise 3D data representing the shape of any surface structures, embossing, or internal structures, such as cavities or ventilation channels. Any of the 3D data relating to the external or internal shape of an item of footwear, a footwear portion or any part thereof may also be obtained from one or more CAD files, e.g., CAD files created during the design of the item of footwear or footwear portion. 3D data may, for example, comprise CAD models, surface models, triangle meshes, point clouds or any other 3D data representation known in the art. Footwear-specific data may comprise 3D data related to the entire item of footwear, or to any of the footwear portions described below, such as a sole, an insole, a midsole, an outsole, an upper, or any part thereof.

In some instances, footwear-specific data may relate to a 2D shape of the footwear item or footwear portion. For example, the footwear-specific data may comprise 2D data representing the shape of the footwear portion, of the item of footwear or any part thereof. For example, the footwear-specific data may comprise a 2D outline of the sole, a 2D outline of the insole, a 2D outline of any part of the upper, a 2D cross section of the sole, the insole, the midsole or the outsole, a 2D cross section of the cavity of the item of footwear, a 2D pattern representing any print, embossing, texture or surface structure present on any surface of the item of footwear or on any footwear portion, or any other 2D outline, 2D cross section, 2D pattern or 2D data useful for the design of custom footwear. Such 2D data may be acquired using a 2D optical scanner, or derived from photographic data, from analog drawings or from digital drawings, such as 2D or 3D CAD files, vector-based files or pixel-based files. 2D footwear-specific data may take the form of CAD files, vector-based files or pixel-based files.

In some instances, footwear-specific data may relate to the appearance of the item of footwear or footwear portion. For example, footwear-specific data may comprise photographic data or descriptive data, such as relating to colors.

In some instances, footwear-specific data may relate to mechanical properties of an item of footwear or of a footwear portion. For example, the footwear-specific data may comprise data relating to a footwear item's or footwear portion's strength and stiffness under loads, such as compression, tension, bending or torsion. Such data may be acquired by means of test benches known in the art, or by in-silico testing, such as finite-element analysis.

In some instances, footwear-specific data may relate to material properties of any material comprised in an item of footwear or a footwear portion, such as material type, material name, chemical composition, presence of reinforcing structures, conductivity, corrosion resistance, density/specific weight, ductility/malleability, elasticity/stiffness (e.g. Young's modulus), fracture toughness, hardness, plasticity, creep, compressive strength, fatigue strength, shear strength, tensile strength, yield strength, flexural strength, flexural modulus, brittleness, toughness, wear resistance, hygroscopy, surface roughness, specific strength, specific modulus, shear modulus, resilience, Poisson's ratio, bulk modulus, flammability, melting point, thermal conductivity, permeability to air or water, and others as are known in the art. Material properties may be acquired by means of any testing equipment known in the art, or looked up in a database or reference source.

### Footwear Portions

A further aspect of the present disclosure relates to footwear portions that may be used in the design of custom footwear.

Custom footwear may comprise one or more individual footwear portions, such as, for example: a body, an insole, a midsole, and an outsole.

The body may be the portion of the footwear (such as a shoe) that surrounds the sides and top of a user's foot and is sometimes referred to as the upper. The body may comprise portions, such as a heel support, ankle support, webbing, laces, straps, tongue, toe cap, vamp, quarter, heel counter, heel tab, eyestay, foxing, mudguard and other structures as are known in the art. In some cases, the body may comprise two or more portions that are selectively bound by a user using, for example, laces or straps.

An insole may be the inner portion of footwear (such as a shoe) that directly contacts the bottom (and to some extent side) of a user's foot. A custom insole may be a fixed (i.e. permanent) portion of a shoe, or a removable portion of a shoe in different instances.

A midsole may be a footwear portion between the insole and the outsole, which, in some instances, is primarily a shock-absorbing portion. In some instances, the midsole may be designed to be primarily responsible for supporting a substantial portion of the weight of a user as well as providing shock-absorbing properties for the footwear while in use. In other instances, the midsole may be designed to enhance the effectiveness of features found in the insole and/or outsole.

The outsole may be the outer-most portion of footwear and may be designed to interface with the ground. In some instances, the outsole is alternatively known as a tread. The outsole may be designed with, for example, structures and/or textures for providing grip to the footwear on a variety of surfaces. Additionally, the outsole may be designed to protect a user's foot from puncture or other harmful intrusion. As with the above, the outsole may additionally be designed to enhance the effectiveness of features found in the midsole.

In some instances, footwear (such as a shoe) may include one or more of the aforementioned portions. Different combinations of these footwear portions are envisioned. For example, particular footwear may have a body, an outsole, and an insole, but lack a midsole. In some instances, one or more of the body, insole, midsole, and outsole may be permanently attached to each other. For example, while being designed separately, and potentially comprising different materials, a body, an insole, a midsole, and an outsole may nonetheless be assembled into an integral item of footwear. In some instances, an item of footwear may include more than one of a particular type of footwear portion. For example, particular footwear may have two or more insoles, e.g., one may be permanently attached to a midsole or outsole and one may be removable from the remainder of the item of footwear. For example, the former may be a standard, off-the-shelf component, while the latter may be a custom footwear portion.

In some instances, one or more of the body, insole, midsole, and outsole and/or parts thereof may be custom footwear portions designed at least in part based on the various types of data described above. In some instances, one or more of the aforementioned footwear portions may comprise one or more materials and/or structures or corrective features. For example, a midsole may comprise various 3D structures meant to absorb shock while reducing the overall weight of the footwear.

In some instances, the custom footwear may be a custom insole. In general, the insole may be an inner portion of footwear that contacts (e.g., directly) the bottom (and to some extent the side(s)) of a user's foot. Insoles may support at least one of the forefoot, midfoot, and hindfoot of the user. Insoles may be fixed (i.e., permanent) in the footwear, or may be removable so that the insoles can be used in different articles of footwear. For example, insoles may be designed to fit inside of ready-to-use footwear. Insoles may be configured to fit inside of footwear before the final footwear product is fully manufactured or ready to use, and may either be permanently affixed to the final footwear product, or may be removable. To facilitate the fit with a particular item of footwear, an insole may be designed based on footwear-specific data. For example, if the footwear-specific data comprises 2D or 3D data relating to the shape of the item of footwear, the insole may be designed to have a contacting surface substantially conforming to a part of the item of footwear, such as a surface of a midsole, a permanently attached insole, an upper or any combination of these.

Insoles may be a standard design and/or insoles may be customized for a specific user, for example by designing the insole based on static and/or dynamic user-specific data as described above.

In some embodiments, the footwear insole may comprise one or more insole section: at least one of a forefoot support, a midfoot support, and a hindfoot support. The insole may be a one-piece structure, for example, where a forefoot support may be attached to a first end of a midfoot support and a hindfoot support may be attached to a second end of a midfoot support. The insole may comprise a base layer, which may comprise one or more of a variable-thickness layer, a directional-stiffness layer, a stability layer, and/or a reinforcement layer. The insole may comprise corrective features specifically designed to affect the fit and/or behavior of the insole when worn and used by a user. In the insole, the forefoot support may comprise structures that are distinct from structures in the midfoot support and/or hindfoot support. For example, the midfoot support and the hindfoot support may comprise a base layer (comprising at least one of a variable-thickness layer, a directional-stiffness layer, a stability layer, and/or a reinforcement layer), while the forefoot support may comprise a plurality of openings, a rim, a first groove and a second groove. In some embodiments, the forefoot support may further comprise at least one notch in the rim.

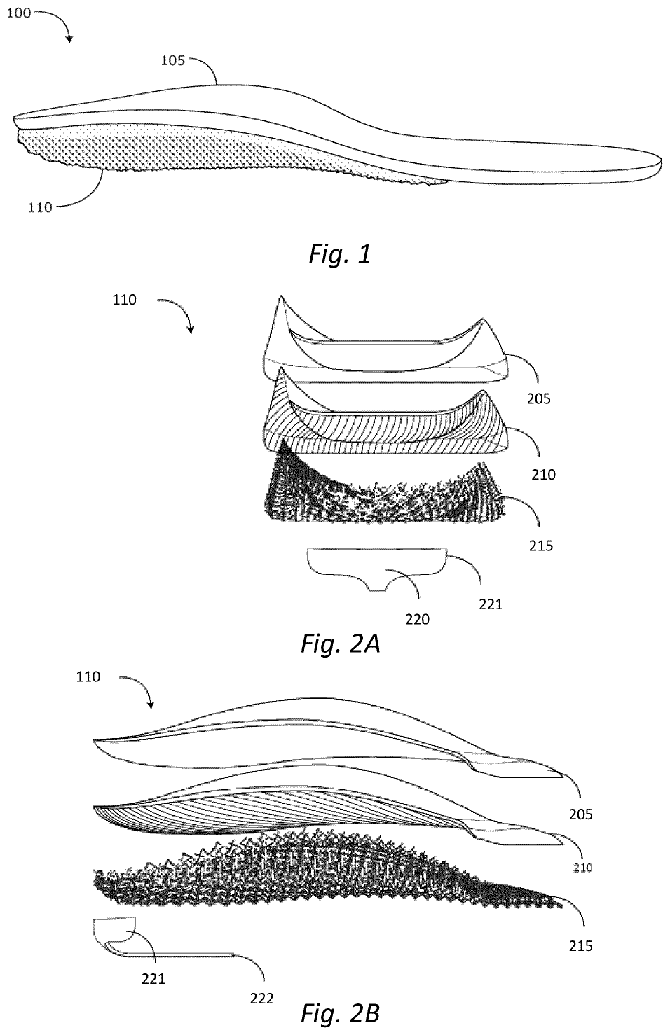

In some embodiments, the design and composition of an insole or an insole section may comprise a soft top layer (e.g., foam, rubber, leather, etc.) affixed (e.g., using adhesive, glue, hook-and-loop fasteners, etc.) on top of a base layer. The base layer may be manufactured using additive manufacturing techniques and made out of a suitable material such as those described herein as being used for additive manufacturing. For example, the base layer may be made of a suitable plastic. In some embodiments, the base layer may be manufactured (e.g., using additive manufacturing also referred to in some cases as 3D printing) as a single part, even in embodiments where the base layer may comprise one or more components. The base layer may cither fully or partially support the top layer. FIG. 1 illustrates an example of such an insole 100. However, the following description applies equally to an insole section, such as a forefoot support, a midfoot support, or a hindfoot support. As shown, the insole 100 includes a soft top layer 105 and a base layer 110. The base layer 110 partially supports the soft top layer 105 in this example, as there is a portion of the soft top layer 105 without support from the base layer 110 underneath.

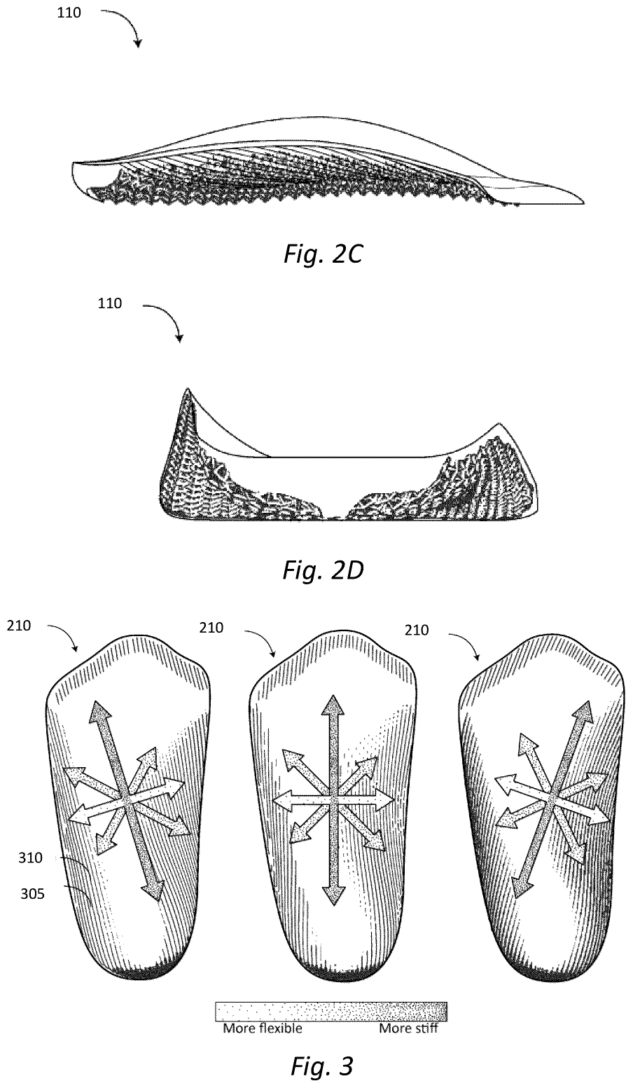

In some embodiments, the base layer 110 may comprise one or more components. For example, as shown in FIGS. 2A, 2B, 2C, and 2D, the base layer 110 may comprise four components including a variable-thickness layer 205, a directional-stiffness layer 210, a stability layer 215, and a reinforcement layer 220. It should be noted that the base layer 110, in some embodiments, may include only some of the components shown in FIGS. 2A, 2B, 2C, and 2D, and/or may include alternative or additional components. Each of the components may be configured to have a particular function or purpose.

The variable-thickness layer 205 may comprise a layer manufactured having variable thickness to control the stiffness of the insole 100 in different zones (i.e., areas or locations). For example, the variable-thickness layer 205 may be generally shaped and customized to the foot of a user, for example based on the data types described herein. The variable-thickness layer 205 may be a solid layer of material and may have generally smooth surfaces. In areas where greater stiffness is required, the variable-thickness layer 205 may be made thicker. In areas where less stiffness is required, the variable-thickness layer 205 may be made thinner. For example, certain portions of the variable-thickness layer 205, such as an area designed to be near the toe of a user, may be made thinner to allow flexibility when walking. Further, in areas such as near the heel of the user, the variable-thickness layer 205 may be made thicker to prevent unwanted flex.

The directional-stiffness layer 210 may comprise a layer designed to be more flexible in certain directions and less flexible in other directions. For example, the directional-stiffness layer 210 may be configured to flex more freely from left to right (i.e., side of foot to side of foot) and constrain flex more from front to back (i.e., toe to heel). In other embodiments, the directions used to constrain or promote flex may be different or customized, for example based on the data types described herein.

The directional-stiffness layer 210 may be generally shaped and customized to the foot of a user, for example based on the data types described herein. The directional-stiffness layer 210 may be a solid layer of material. The directional-stiffness layer 210 may comprise a series of bending lines, ribs, cuts, striations, waves, grooves, or other patterns 305, for example as shown in FIG. 3. The patterns 305 may be formed on one or more surfaces of the directional-stiffness layer 210. For example, the bottom surface, i.e. the surface facing the ground when the insole is worn by the user, of the directional-stiffness layer 210 may have the patterns 305 formed thereon, and the top surface, i.e. the surface opposite the bottom surface, of the directional-stiffness layer 210 may be generally smooth. In other examples, the top surface of the directional-stiffness layer 210 may have the patterns 305 formed thereon, and the bottom surface of the directional-stiffness layer 210 may be generally smooth. In yet other examples, both the bottom and top surfaces of the directional-stiffness layer 210 may have the patterns 305 formed thereon.

The directional-stiffness layer 210 may be more flexible in the direction perpendicular to the patterns 305. Accordingly, the directional-stiffness layer 210 may be less flexible (i.e., more stiff) in the direction parallel to the patterns 305.

Patterns 305 (e.g., bending lines, ribs, cuts, striations, waves, grooves, or other) may be straight or curved. The direction of the patterns 305 may vary between the forefoot, midfoot, and hindfoot zones of the insole, and even within each zone. For example, the patterns 305 may be designed to accommodate or correct the roll-off pattern of the user's foot based on dynamic user-specific data, such as a dynamic pressure measurement. The roll-off pattern may be corrected based on statistical data, such as statistical data characterizing users, such as athletes, who perform at a high level without injuries over long periods of time.

The stability layer 215 may comprise a layer configured to flex or flatten in different regions to increase stability in those regions. For example, the stability layer 215 may comprise an ordered structure, for example comprising a plurality of unit cells configured to flex with respect to each other. In other examples, the stability layer 215 may comprise an unordered structure, such as an unstructured arrangement of elongate struts, an open-pore foam or a closed-pore foam, all configured to flex under loads. For example, the structure may be configured to flex, deform, and/or compress in certain directions when pressure is applied, and then return to its original form when pressure is removed. Further, the structure may be a lightweight structure. The stability layer 215 may be generally shaped and customized to the foot of a user and/or to the item of footwear in which the insole will be worn, for example based on the data types described herein. In some embodiments, the shape and design of the structure, for example the shape and placement of unit cells in the stability layer 215, may be configured or customized, for example based on the data types described herein.

In some embodiments, particularly where a stability layer is combined with a directional-stiffness layer, an ordered structure of the stability layer may be designed such that its mechanical properties, such as its stiffness, do not cancel out or overshadow the effect of the directional-stiffness layer. For example, using the available design variables (e.g. unit cell design, design, length and cross section of struts, design and size of nodes between struts) an ordered structure may be designed that offers greater stiffness in a direction perpendicular to the directional-stiffness layer, e.g. to carry the weight of the user or the impact loads during dynamic activities, than in a direction parallel to the directional-stiffness layer.

In other embodiments, the stability layer, such as stability layer 215, may be designed to also fulfill the purpose of a directional-stiffness layer, such as directional-stiffness layer 210. For example, by choosing a particular orientation for an ordered structure, and using the design variables listed above (e.g. unit cell design, design, length and cross section of struts, design and size of nodes) an ordered structure may be designed that offers greater resistance to bending in a first direction than to bending in a second direction perpendicular to the first direction.

In some embodiments, the unit cells of the stability layer 215 may be designed to be manufactured using additive manufacturing techniques (e.g., 3D printing) collectively as a single-form design (i.e., one integral part).

Unit cells and ordered structures have been described above in the context of the stability layer 215. However, a person skilled in the art will readily appreciate that the aspects and features described herein also apply to unit cells and ordered structures in other footwear portions or parts of footwear portions.

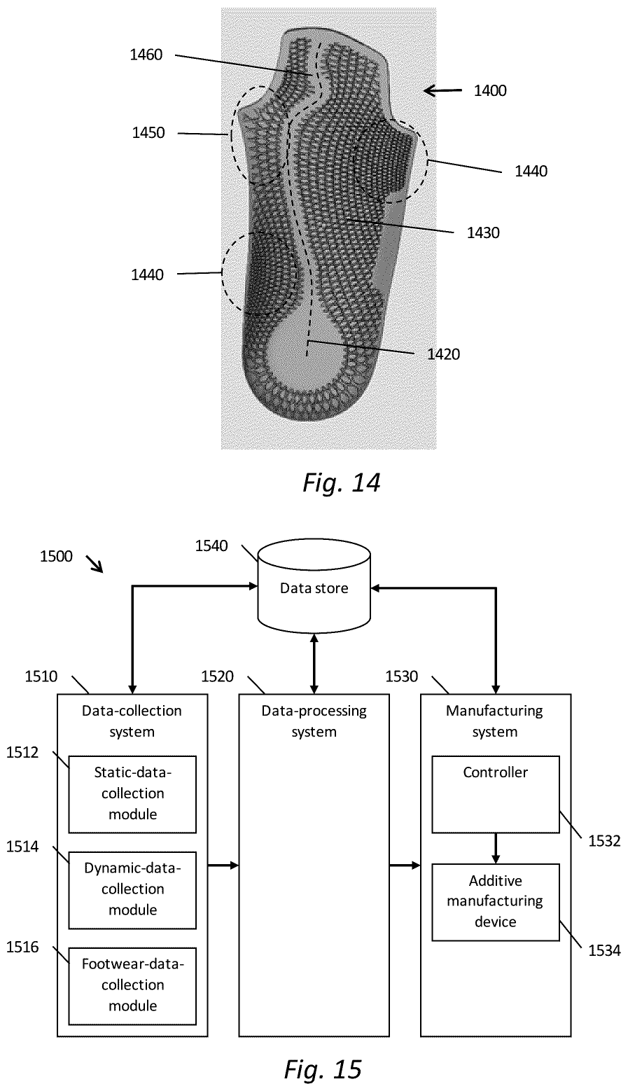

In some embodiments, stability layer 215 may additionally or alternatively comprise a surface texture, such as an ordered or unordered pattern indented into or outdented onto a surface. For example, FIG. 14 shows a bottom view of an insole 1400 of which the stability layer comprises a surface texture 1430. Such a surface texture 1430 may increase the grip of an insole onto the internal surfaces of the item of footwear in which it is to be worn. It may therefore increase stability by reducing the risk of the insole sliding around in the item of footwear during use. In some instances, for example, where the insole is subdivided into discrete areas, each with a specific insole thickness, e.g. as determined based on a required local resistance to bending, a surface texture may bridge and smoothen any sharp borders between such areas. For example, such subdivided discrete areas may include thickness zones 1440, 1450. As such, a surface texture may reconcile local thickness variations with both a smooth top surface configured to contact the foot of the user and a collection of point, line or surface contacts configured to stably contact an item of footwear in which the insole is to be worn.

In some embodiments, such as shown in FIG. 4, the stability layer 215 includes flattened areas (such as compared to not flattened areas shown in FIG. 5). For example, the structure may be designed to have a flatter shape in certain areas. These flattened areas may, for example, enhance stability (e.g., mediolateral stability). For example, the flattened areas may include a flattened heel area 405 and/or a flattened ball of the foot area 410 of the stability layer 215.

Further, in some embodiments, the stability layer 215 may be configured to compensate for certain variables, such as difference in leg length or movement of the foot, e.g. based on static or dynamic user-specific data. For example, as shown in FIG. 6, a stability layer 605 for a left leg may be made shorter than a stability layer 610 for a right leg to compensate for a difference in length between the left and right legs, which may be comprised in static user-specific data. The stability layer 215 may be made thinner or thicker (i.e., shorter or taller) by using fewer or more unit cells, respectively, in the design of the stability layer 215. Alternatively, the stability layer 215 may be made thinner or thicker (i.e. shorter or taller) by reducing or increasing the heights of the unit cells, respectively, in the design of the stability layer 215. In some embodiments, the stability layer 215 may be configured to correct certain movement of the foot of the user. For example, the stability layer 215 may be configured to correct pronation and/or supination, such as by tilting the structure of the stability layer 215 to the medial or lateral side.

The reinforcement layer 220 may comprise a layer formed to fit around the heel edge of the insole 100. The reinforcement layer 220 may be generally shaped and customized to the heel of a user, for example based on the data types described herein. The reinforcement layer 220 may be a solid layer of material and may have generally smooth surfaces. The reinforcement layer 220 may provide additional strength in the heel area that may be subject to high tensile forces at heel impact such as illustrated in FIG. 7. The reinforcement layer 220 may be of a sufficient thickness to provide the needed strength. For example, the reinforcement layer 220 may be configured to provide support in response to tensile forces from rotation of the base layer 110, such as during heel impact. These tensile forces may cause the base layer 110 to crack, unless the reinforcement layer 220 is provided to prevent such cracking by at least in part counteracting the tensile forces. Accordingly, the reinforcement layer 220 may include portions 221 that are configured to extend along the lateral sides near the heel of the base layer 110 as shown. These portions 221 may help to compensate for tensile forces caused by rotation of the base layer 110 during heel impact. Further, the reinforcement layer 220 may include a portion 222 configured to extend along the bottom near the heel of the base layer 110. The portion 222 may provide reinforcement to compensate for forces pushing down on the base layer 110, such as due to heel impact.

In some embodiments, a custom insole may further comprise a forefoot support. Such a forefoot support may be flexible and is preferably durable. One aspect of the present disclosure relates to a forefoot support of a footwear insole that provides ventilation, comprising a plurality of openings; a rim configured to form a border around at least a portion of the forefoot support; a notch in said rim; a first groove traversing the forefoot support along a first axis, wherein the first groove is configured to provide flexibility to the forefoot support in a first direction; and a second groove traversing the forefoot support along a second axis, wherein the second groove is configured to provide flexibility to the forefoot support in a second direction. It should be noted that each of these features may be optional and every combination of features may fall within the scope of the present disclosure. For example, a forefoot support may comprise any of the combinations listed in Table 1. Table 1 below provides a non-exhaustive list of combinations of features that may be comprised in a forefoot support according to different embodiments of the present disclosure, wherein each column represents a different combination and an X in a column indicates that a certain feature is present in the combination of that column.

TABLE 1

| | | | | | | | | | |
|---|---|---|---|---|---|---|---|---|---|
| A plurality of openings | X | X | X | X | X | X | X | X | X |
| A rim | X | X | X | X | X | X | | | |
| A notch in the rim | X | X | X | | | | | | |
| A first groove traversing the | X | X | | X | X | | X | X | |
| forefoot support along a first axis | | | | | | | | | |
| A second groove traversing the | X | | | X | | | X | | |
| forefoot support along a second | | | | | | | | | |
| axis | | | | | | | | | |
| A plurality of openings | | | | | | | | | |
| A rim | X | X | X | X | X | X | | | |
| A notch in the rim | X | X | X | | | | | | |
| A first groove traversing the | X | X | | X | X | | | X | X |
| forefoot support along a first axis | | | | | | | | | |
| A second groove traversing the | X | | | X | | | | X | |
| forefoot support along a second | | | | | | | | | |
| axis | | | | | | | | | |

Also envisaged is a forefoot support comprising no plurality of openings; no rim; no first groove traversing the forefoot support along a first axis; and no second groove traversing the forefoot support along a second axis.

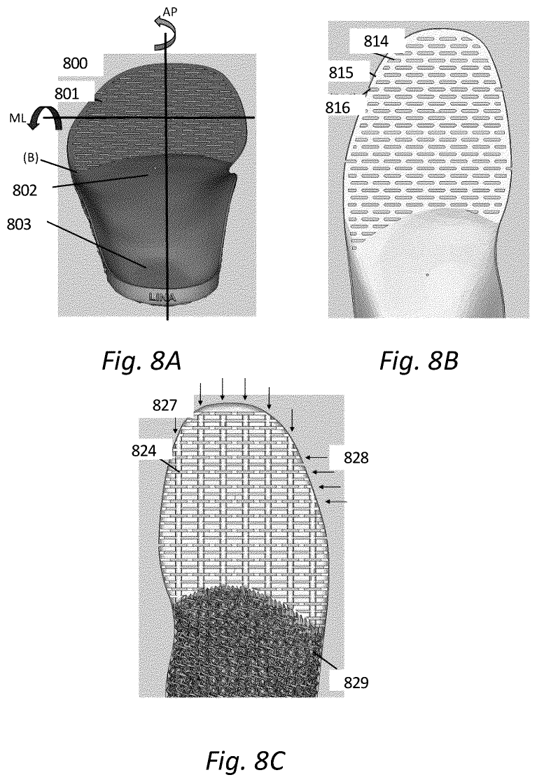

FIGS. 8A-8C show an example of a forefoot support. FIG. 8A is a perspective view of the top surface of the insole, which is configured to contact the sole of a user's foot. In FIG. 8A, the insole 800 is a one-piece structure comprising a forefoot support 801 that may be connected to a midfoot support 802 and a hindfoot support 803. The border between the forefoot support 802 and midfoot support 803 is indicated by the letter “B”, and the different structures of the forefoot support and the midfoot support are apparent on each side of the border. A border between the midfoot and hindfoot support is not indicated, as the structures of these regions may be similar. FIG. 8B shows the top view of the forefoot support, at the top surface which may be configured to contact the user's forefoot. The forefoot support comprises a plurality of openings 814, a rim 815, and a notch in the rim 816. FIG. 8C is a view of the bottom of the insole, which may be configured to contact the item of footwear or another footwear portion (e.g., a midsole or an outsole of the item of footwear). In this view, a first groove in one direction 827 may be repeated (vertical arrows indicate most but not all grooves in this direction) and a second groove in a second direction 828 may be repeated (horizontal arrows indicate most but not all grooves in this direction). Example structures in the bottom surface of the midfoot support are visible 829. An opening 824 is shown. The combination of structural features in this forefoot support may confer flexibility around the anterior-posterior (AP) axis and the medial-lateral (ML) axis, as indicated by the arrows in FIG. 8A.

For flexibility, openings may be configured to enable bending of the insole in one or more directions. Insoles may be made of a material that is resilient, in order to provide support for the user's foot, but resilient materials such as firm plastics or polyamides may be too stiff to bend or twist when the foot is moving. Openings may be configured to confer flexibility in stiff materials that do not otherwise bend.

For ventilation, moisture and heat from inside the footwear and air from outside the footwear should be able to circulate. In the forefoot support described herein, the plurality of openings allows air to flow around the forefoot structure, while heat and moisture from the user's foot can escape. In some embodiments, the plurality of openings may be arrayed in a line, which may be straight, curved, or a combination of both. The line may follow a contour of the user's anatomy or may be placed in a region that will support the forces applied when the user's foot is in motion. The location of the openings may also correspond to an area of the user's foot with high levels of heat and/or moisture. In some embodiments, the plurality of openings may be arrayed in one line, or in multiple lines. The multiple lines may be arrayed in rows, as in FIGS. 8A-8C. The rows may be evenly spaced apart.

Each of the plurality of openings may have a different shape, or all of the openings may have the same shape. For example, the openings may be rectangles, rounded rectangles or portions of rectangles (see 814 in FIG. 8B and 824 in FIG. 8C). In some embodiments, each of the openings in the plurality may be rectangular, and the openings may be arrayed in repeating rows. The rows of rectangular openings may span the entire surface of the forefoot support, as in FIGS. 8A and 8B. The plurality of openings may be regularly spaced apart. The plurality of openings may be staggered, so that each row of openings is offset relative to the row of openings adjacent to it. The rectangles may be truncated at the edges of the forefoot support.

The plurality of openings may be arrayed in a pattern or may be randomly arrayed. In some embodiments, openings may be spaces in between beams in a microstructure, an ordered structure, or a lattice structure. For example, a lattice may be a woven lattice, or may comprise an array of unit cells wherein each unit cell comprises at least one wall and one opening. Openings may also be placed in a direction corresponding to the direction that a user's foot will move, so that the opening may be configured to provide flexibility to the insole in the direction of movement.

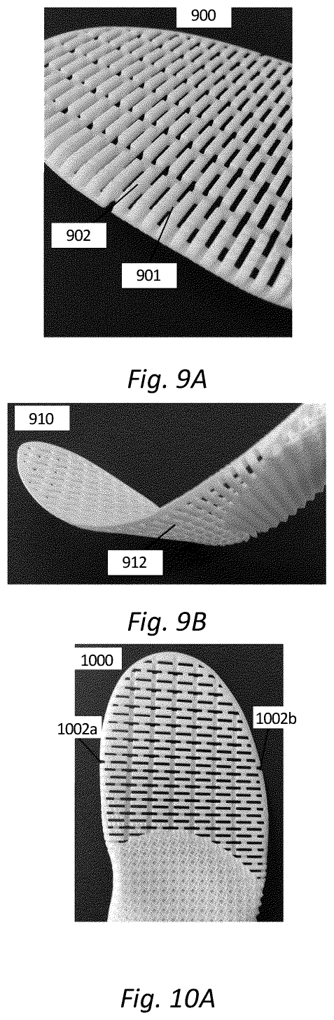

The grooves in the forefoot support may confer further flexibility and may be configured to provide flexibility in a desired direction (or directions), and to a greater or lesser extent, depending on the user's needs. As shown in FIG. 8C, a first groove 827 and a second groove 828 may be located in the bottom surface of the forefoot support. The bottom surface of the forefoot support may be configured to contact a surface on a footwear article and not contact the sole of a user's foot. It should be noted that, in other embodiments, grooves may additionally or alternatively be present on the top surface of the forefoot support. The first groove and/or the second groove may be repeated to create a plurality of first grooves and/or a plurality of second grooves. The location of the openings may be either completely or partially in a groove. For example, in FIG. 8C, opening 824 lies completely in a horizontal groove 828, and partially in a vertical groove 827. In certain embodiments, the openings, whether arrayed in one line or multiple lines, may be located in the first groove traversing the forefoot support, the second groove traversing the forefoot support, or both the first groove and the second groove.

Where the first groove and the second groove intersect, recessed structures may be formed. These recessed structures may be separated by raised structures. The first groove and the second groove may be configured to provide greater flexibility when the raised structures are bent away from one another than when the raised structures are bent towards one another. For example, the grooves and raised structures may be designed such that, in the latter case, the raised structures collide upon a certain degree of bending. FIGS. 9A-9B show a view of the bottom surface of a forefoot support 900. FIG. 9A shows the recessed structures 901 and raised structures 902 that are generated by the intersecting grooves. FIG. 9B shows the flexibility of the forefoot support 910 when the raised structures such as 912 are bent away from one another. This directional flexibility is configured to allow the forefoot support to bend with the user's foot. The shape of the raised and recessed structures may vary, depending on the shape of the first groove and the second groove. In some embodiments, the first groove and the second groove may be polygonal, for example, rectangular. The raised structures created by these example rectangular grooves may also be rectangular in shape. In some embodiments, either of the first and second grooves may have a rounded-off cross section, e.g., so as to reduce the risk of cracking or crack propagation.

The dimensions of the first groove and the second groove may correspond to the dimensions of the forefoot support, or may correspond to regions of a user's foot. For example, a first groove that traverses the length of the forefoot support may traverse the entire length of the forefoot support (i.e., from a point on the rim at the distal end of the insole to a point at the border where the forefoot support meets the midfoot support), or may partially traverse the length of the forefoot support. Similarly, a second groove that traverses the width of the forefoot support may traverse the entire width of the forefoot support (i.e., from one point on the rim of the medial—or inner—side of the forefoot support to another point on the rim of the lateral—or outer—side of the forefoot support), or may partially traverse the width of the forefoot support. In certain embodiments, a first groove may traverse an entire line between two points on the rim of the forefoot support.

Flexibility of the forefoot support results from the bending of the first groove and the second groove. Accordingly, the grooves may be configured in any direction in which flexibility of the forefoot support is desired. Flexibility may be desired to permit movements of the metatarsophalangeal (MTP) joints in the forefoot, such as flexion, extension, abduction, adduction and circumduction. The forefoot support may bend in the same direction as the user's foot during walking or running. The forefoot support may bend in a direction that facilitates the insertion or removal of the insole into the article of footwear. In some embodiments, the forefoot support may be flexible in a direction around a medial-lateral axis, may be flexible in a direction around an anterior-posterior axis, or may be flexible in both directions.

The first groove may traverse the forefoot support along an anterior-posterior axis. The second groove may traverse the forefoot support along a medial-lateral axis. The first groove and/or the second groove may traverse the forefoot support along an angle relative to either the anterior-posterior axis or to the medial-lateral axis. A plurality of grooves may be substantially parallel to the first groove and/or a plurality of grooves may be substantially parallel to the second groove. Within each one of the grooves in the plurality of grooves in the first direction, in the second direction, or in both directions, there may be the plurality of openings. Thus, any given opening may be arrayed in the grooves, either partially or completely. In FIG. 8C, opening 824 lies completely in groove 828, while a portion of opening 824 lies in groove 827.

The first groove and the second groove may be arranged at an angle relative to each other. The angle may be 90°, substantially equal to 90°, or any other angle. Grooves may be present on the top surface of the forefoot support and/or on the bottom surface of the forefoot support. In some embodiments, at least a first groove traverses the top surface of the forefoot support and at least a second groove may traverse the bottom surface of the forefoot support.

The rim of the forefoot support may provide stability and strength. In the absence of a rim, the edge of the forefoot support may have a groove, a raised structure, a recessed structure, or a portion of any of these. The variation in structures at the edge of the forefoot support may create a rough finish, and any protruding portions of a structure could be caught in the footwear during insertion or removal of the insole, or during use of the insole. The rough finish could also cause discomfort to the user, for example, if protruding portions become lodged in the user's foot or socks. The rough finish would also be vulnerable to tearing if stress is placed or concentrated on an area where structures are exposed, particularly the recessed structures which are thin. In some embodiments, the rim may span the entire edge of the forefoot support. Alternatively, the rim may span only a portion of the edge of the forefoot support, for example, only the anterior edge, the medial (inner) edge or the lateral (outer) edge, or any combination thereof.

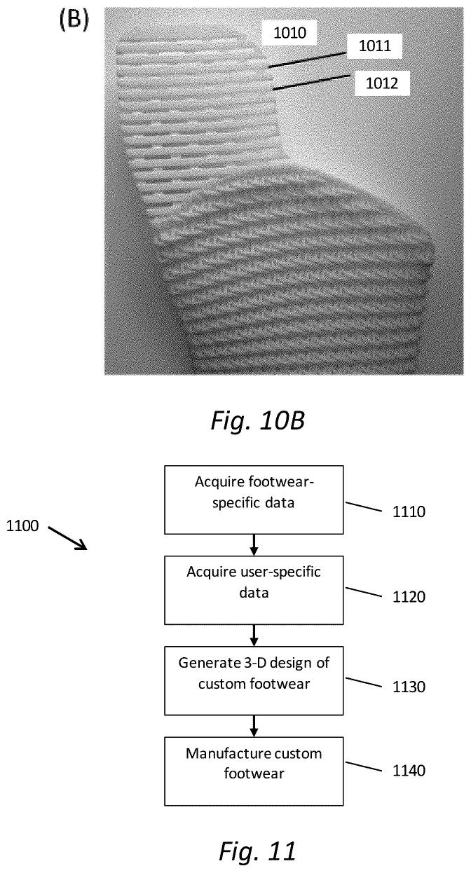

In some embodiments, the edge of the forefoot support may have a dangling structure or a dangling end, for example, where a portion of an opening is cut off at the border of the forefoot support (see dangling ends 1011 and 1012 in FIG. 10B). The rim around the forefoot structure may comprise a loop or a beam that connects two or more dangling ends. In some embodiments, the rim may comprise a series of beams that connect each dangling end to at least one other dangling end. The series of beams may or may not be a contiguous series.

A rim may be broader in some regions of the forefoot support than in others, for example, to cover more of the surface area of the forefoot support or may be thicker in some regions than in others. In some embodiments, a portion of the rim may comprise structures such as undercuts or perforations.

In certain embodiments, the rim may comprise one or more notches. FIG. 10A shows the bottom surface of an example forefoot support 1000, wherein the rim may comprise two notches 1002a and 1002b. A notch may be positioned to correspond to joints in a user's forefoot, for example, at the location on the rim of the forefoot support that corresponds to a user's metatarsophalangeal (MTP) joints.

The forefoot support may be large enough to support the entire forefoot of the user, including all the phalanges. The forefoot support may be sized to support the entire forefoot, plus some additional area in order to fill as completely as possible the shoe in which it will be placed. In certain embodiments, the forefoot support may be smaller than the forefoot of the user and provides support only to a region of the forefoot. FIG. 10B shows the bottom surface of an example forefoot support 1010 that may support only the medial (inner) side of the user's forefoot. As the forefoot support may be configured to align the user's foot, knee and/or hip, either all or a portion of the user's forefoot may be supported.

As described above, an insole section, such as a forefoot support, may further comprise a soft top layer (e.g., foam, rubber, leather, etc.) affixed (e.g., using adhesive, glue, hook-and-loop fasteners, etc.) on top of the insole section's base layer.

While the forefoot support described herein may be a part of a standard insole that is configured to fit any of a number of users (one size fits all) or shoes, a custom forefoot support offers a better fit for the user and the ability to customize the forefoot to the type of shoe, for example based on the footwear-specific data as described above. Custom forefoot support may also be used to correct certain conditions in the user, or to correct or improve the static and dynamic pressures on the foot. Custom forefoot support may also be used to prevent injuries or forestall the onset of foot conditions, such as stress-related injuries to the foot, ankle, leg, knee, hip, or back. For athletes, custom forefoot support may be used to improve biomechanical performance, for example, by altering the angle of impact of a user's foot during dynamic activities such as running and thereby increasing the overall speed of the running. Similarly, if the forefoot support provides optimal alignment of a user's feet, knees, and hips during activities such as cycling, then the power, endurance, and comfort of the cyclist should be improved.

Custom forefoot supports may be designed using data regarding a particular user's physical characteristics or attributes, e.g., static user-specific data as described above. For example, a user's foot size and static foot pressure (e.g., when standing) may be measured.

Custom forefoot supports may also be designed using dynamic user data as described above, such as dynamic foot pressure measurements. For example, the dynamic pressures on a user's foot may be measured during dynamic foot activities, such as: running, walking, jumping, landing, pivoting, rolling, rocking, etc. Virtually any functional biomechanical measurements may be used during the design of custom footwear.

Custom forefoot supports may also be designed using non-user-specific data, such as statistical population data. For example, the average shape of a foot of a certain size may be statistically determined, or otherwise available from existing statistical datasets. Further, the statistical averages for these and other physical foot characteristics may have associated statistical parameters, such as distributions, standard deviations, variances, and others as are known in the art. In this way, knowing a single foot characteristic associated with a user, such as a shoe size, may enable the use of many associated statistical foot characteristics (e.g., shape, size, etc.).

Custom forefoot supports may also be designed using footwear-specific data. For example, an item of footwear may comprise certain ventilation channels, such as in its sole, midsole, insole or any part of its upper. A custom forefoot support for a removable insole to be combined with said item of footwear may be designed with a plurality of openings that are located in line with these ventilation channels, such that air and moisture can circulate freely through the plurality of openings to and from the ventilation channels. To this end, it may be advantageous if the footwear-specific data relating to the item of footwear comprises 2D or 3D data relating to the shape and/or location of the ventilation channels with respect to the shape of the item of footwear. Alternatively or additionally, the footwear-specific data relating to a 2D or 3D shape of the item of footwear may be used to design the shape of the custom forefoot support. For example, a 2D projection of the inner cavity of the item of footwear may be used to design the outline of the custom forefoot support in order for the forefoot support to fill the item of footwear as completely as possible, as described above, and/or 3D shape data of a top surface of a midsole or fixed insole of the item of footwear may be used to design the underside of the forefoot support—i.e. the side of the custom forefoot support facing away from the user—to conform to the shape of said surface. For example, the heights of the raised structures 902 in FIG. 9A may be configured such that the raised structures as a group match the shape of said surface, without the custom forefoot support having to deform.

As the arrangement of grooves in the forefoot support may confer flexibility, the grooves may be tailored to the user's need for flexibility.

### Corrective Features in Footwear

Custom footwear may include one or more corrective features specifically designed to affect the fit and/or behavior of the footwear when worn and used by a user. For example, one or more components of an insole may be shaped accordingly to include one or more corrective features (e.g., corrective structures). To this end, the custom footwear may be designed using any of the data types described above. Examples of corrective features may be: areas of reduced thickness, local indentations, areas of increased thickness, directional stiffness features, microstructures, surface features, areas of reduced stiffness, areas of increased stiffness, areas of reduced firmness, areas of increased firmness, plantar fascial grooves, heel pads, local indentations under the heel, full-length offsets, heel raises, full-length wedges, full-width wedges, heel cups, heel wedges, heel skives, navicular supports, lateral arch fills, raised lateral edges, raised medial edges, metatarsal supports, such as metatarsal bars or metatarsal pads, metatarsal reliefs, such as metatarsal depressions or metatarsal cut-outs, kinetic wedges, forefoot supports, forefoot wedges, toe raises, such as Cluffy wedges, Morton's extensions, and reverse Morton's extensions, all of which are described below in more detail. Some of these corrective features may be applicable to the entire foot. Others may be applicable to certain areas of the foot, such as the hindfoot, midfoot, forefoot, toes or individual toes.

In some embodiments, corrective features may be meant to correct anatomical or biomechanical problems or conditions with a user's foot. For example, a user may have a relatively high arch, which creates support issues with regular footwear. As such, custom footwear may include a custom footwear portion, such as an insole, that adds support underneath the high arch in order to better distribute the user's weight in the footwear.

In some embodiments, corrective features may be meant to prevent injury rather than to correct an injury or anatomical problem or condition. For example, dynamic data can be used to determine the balance of a user's foot during movement (e.g. when running). The determined balance may be compared to optimal balance sequences, which may be derived from dynamic or statistical data characterizing users, such as athletes, who perform at a high level without injuries over long periods of time. Thus, corrective structures may be designed to promote better foot balance during movement in order to prevent injury.

In further embodiments, corrective features may be meant to improve performance rather than to correct an existing or potential problem. For example, it has been shown that characteristics related to initial foot contact during running may be related to running speed in athletes. With this in mind, dynamic data may be collected to determine characteristics of a user's initial foot contact during running, such as: landing zone (e.g. heel, midfoot, forefoot); the ratio between the respective forces acting on the medial part and the lateral part of the foot; the maximum forces on the landing; the speed of the unreeling of the foot; and others as are known in the art. Based on these determinations, custom footwear, or a custom footwear portion, such as an insole, midsole or outsole, can be configured to alter the user's initial foot contact when running to improve running speed and/or efficiency.

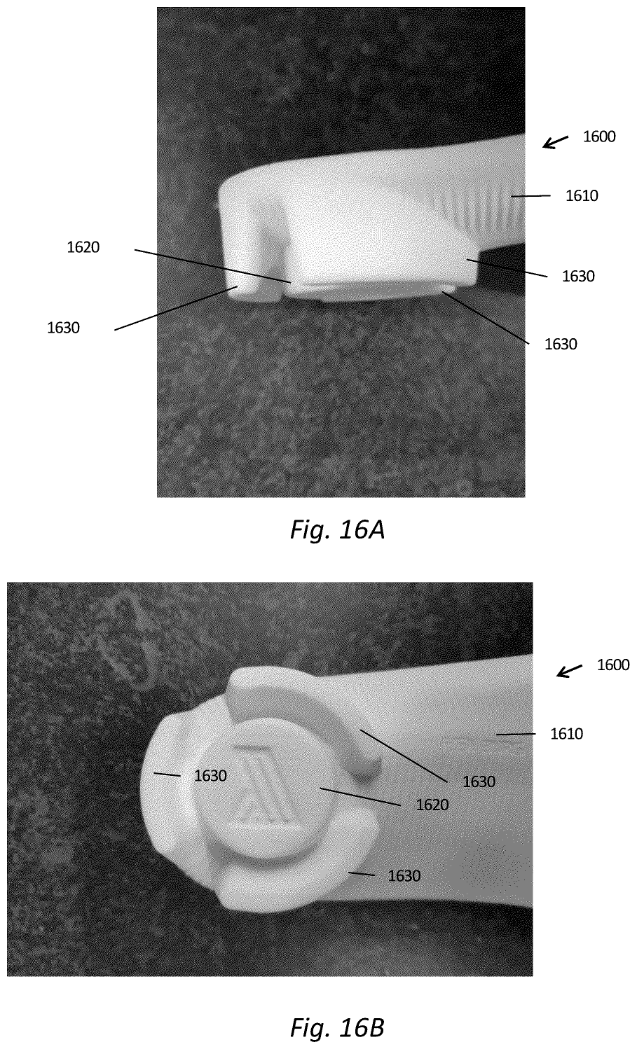

FIGS. 16A-16B show an example of a corrective feature added to a custom insole 1600. The corrective feature may be a heel raise, and may be added to a custom insole 1600, e.g., to treat certain adverse conditions, such as Achilles tendinopathy, calcaneal apophysitis and others, or to compensate for a difference in length between the user's left and right legs. The depicted heel raise may comprise a central post 1620 and three peripheral posts 1630. It should be noted that there can be one or more peripheral posts 1630. It should also be noted that, in some embodiments, the heel raise may only comprise a central post 1620, while in others, it may only comprise one or more peripheral posts 1630. The height of the heel raise may be determined based on the condition to be treated and/or the leg-length difference to be compensated for. The central post 1620 may have a substantially cylindrical shape. It may be ideally added to the underside 1610 of custom insole 1600 underneath the center of the heel region of the insole. In that location it can transfer the bulk of the weight of the user while the user is standing or during the gait cycle upon landing of the heel. To help save material and not make the insole overly rigid, the central post 1620 may not cover the entire heel area. Instead, it may be dimensioned smaller than the heel area but large enough to offer sufficient mechanical strength to bear the weight of the user. A smaller central post 1620 may, however, increase the risk of instability. To reduce this risk, the central post 1620 may be located centrally underneath a center-of-pressure point (COP point) derived from a static pressure measurement or the heel landing time point of a dynamic pressure measurement, instead of underneath the center point of the heel area. The COP point derived from a pressure measurement may be the center of gravity of the total pressure exerted by the user's foot or by a certain region of the user's foot, such as the heel, midfoot or forefoot, onto the pressure-sensitive pad or mat at a particular time point. In other words, this is the location in which a single force vector could balance the total pressure exerted by the user's foot or the relevant region of the user's foot at a particular time point. From a static pressure measurement, one may derive a single COP point for the entire foot or the relevant region. From a dynamic pressure measurement, one may derive one COP point for every single time point of the measurement based on the entire pressure exerted onto the pressure-sensitive device at that time point. In some embodiments, the central post 1620 may be located underneath a COP point of the heel region derived from a static pressure measurement. In other embodiments, the central post 1620 may be located underneath a COP point derived from the heel landing time point of a dynamic pressure measurement. It should be noted that the term “underneath” refers to the vertical direction in a situation in which the custom insole is worn by a user standing up. In cases where the custom insole is designed to have corrective features that alter the position of the foot, such as a heel skive, this direction may differ from the direction normal to the surface of the pressure-sensitive device.

Additionally or alternatively, one or more peripheral posts 1630 may be added to the central post 1620. As these are less involved in the transfer of the user's weight than the central post, they may remain slimmer. By keeping them detached from the central post 1620, the flexibility of the insole is less influenced. The peripheral posts 1630 may take the form of one or more posts distributed around the central post 1620. They may have a ring-shaped, an arc-shaped, a crescent-shaped or any other cross section, such as a shape based on one or more offsets of the cross section of a central post or a shape that is not based on the shape of the cross section of the central post, such as a circular, rectangular or triangular shape. Material may be reduced and flexibility may be increased by having a plurality of smaller, disjoint peripheral posts 1630, rather than one large, ring-shaped peripheral post. In some embodiments, only peripheral posts 1630 may be present. These may be ideally distributed around the center of the heel area or around a COP point derived from a static pressure measurement or the heel landing time point of a dynamic pressure measurement, as described above. Central post 1620 and peripheral posts 1630 may or may not have constant cross sections. They may, for example, have larger cross sections at their proximal ends where they attach to the remainder of the custom insole for increased mechanical strength, and/or at their distal ends for greater stability during use, while having smaller cross sections in between for reduced weight and material usage.

### Footwear Items

A further aspect of the present disclosure relates to an item of footwear, either custom, comprising a fixed or removable custom footwear portion as described above.

A wide variety of types of footwear items are known in the art, such as shoes, boots, sandals, skates, slippers or any combination of these. Boots may, for example, be low boots or high boots, such as horseback-riding boots. Shoes or boots may be specialized for sports, such as athletics, walking, jogging, running, cycling, skiing, dance, such as ballet, tennis, basketball, American football, hockey, ice hockey, ice skating, soccer, fitness and training, skateboard, golf, athletics, hiking, volleyball, padel, rock climbing, surfing, canyoning, boxing, wrestling, badminton, cricket, baseball, korfball, table tennis, rugby or any other sports, e.g. played on a field, on a court, in a ring, on open terrain or in water. The systems, methods, custom footwear portions and corrective footwear features described herein may be applied to any of these types of sport shoes or boots, or subtypes of shoes or boots. For example, within the category of cycling shoes, there are road-bike shoes, mountain-bike shoes, indoor-cycling shoes, and cycling sandals. An example forefoot support may be shaped to fit into a cycling shoe in any one of these categories. Cycling shoes are typically designed to be aerodynamic, curved, and lightweight. Forefoot support in such shoes should be flexible so they fit the contours of the curved shoes, ventilated for the user's comfort and performance, and thin. The systems, methods, custom footwear portions, and corrective footwear features disclosed herein relate to any kind of footwear, and in particular to any of the kinds listed here.

### Additive Manufacturing

Custom footwear can be manufactured using additive manufacturing techniques. Many methods of additive manufacturing are known in the art, such as: Stereo lithography (SLA), Selective Laser Sintering (SLS), Selective Laser Melting (SLM) and Fused Deposition Modeling (FDM), among others.

Stereo lithography (SLA) is an additive manufacturing technique used for “printing” 3D objects one layer at a time. An SLA apparatus may employ, for example, a laser to cure a photo-reactive substance with emitted radiation. In some embodiments, the SLA apparatus directs the laser across a surface of a photo-reactive substance, such as, for example, a curable photopolymer (“resin”), in order to build an object one layer at a time. For each layer, the laser beam traces a cross-section of the object on the surface of the liquid resin, which cures and solidifies the cross-section and joins it to the layer below. After a layer has been completed, the SLA apparatus lowers a manufacturing platform by a distance equal to the thickness of a single layer and then deposits a new surface of uncured resin (or like photo-reactive material) on the previous layer. On this surface, a new pattern is traced thereby forming a new layer. By repeating this process one layer at a time, a complete 3D part may be formed.

Selective laser sintering (SLS) is another additive manufacturing technique used for 3D printing objects. SLS apparatuses often use a high-powered laser (e.g. a carbon dioxide laser) to “sinter” (i.e. fuse) small particles of plastic, metal, ceramic, or glass powders into a 3D object. Similar to SLA, the SLS apparatus may use a laser to scan cross-sections on the surface of a powder bed in accordance with a CAD design. Also similar to SLA, the SLS apparatus may lower a manufacturing platform by one layer thickness after a layer has been completed and add a new layer of material in order that a new layer can be formed. In some embodiments, an SLS apparatus may preheat the powder in order to make it easier for the laser to raise the temperature during the sintering process.

Selective Laser Melting (SLM) is yet another additive manufacturing technique used for 3D printing objects. Like SLS, an SLM apparatus typically uses a high-powered laser to selectively melt thin layers of metal powder to form solid metal objects. While similar, SLM differs from SLS because it typically uses materials with much higher melting points. When constructing objects using SLM, thin layers of metal powder may be distributed using various coating mechanisms. Like SLA and SLS, a manufacturing surface moves up and down to allow layers to be formed individually.

Fused Deposition Modeling (FDM) is another additive manufacturing technique wherein a 3D object is produced by extruding small beads of, for example, thermoplastic material from an extrusion nozzle to form layers. In a typical arrangement, the extrusion nozzle is heated to melt the raw material as it is extruded. The raw material then hardens immediately after extrusion from a nozzle. The extrusion nozzle can be moved in one or more dimensions by way of appropriate machinery. Similar to the aforementioned additive manufacturing techniques, the extrusion nozzle follows a path controlled by CAD or CAM software. Also similar, the part is built from the bottom up, one layer at a time.

Objects may be formed by additive manufacturing apparatus using various materials, such as: polypropylene, thermoplastic polyurethane, polyurethane, acrylonitrile butadiene styrene (ABS), polycarbonate (PC), PC-ABS, PLA, polystyrene, lignin, polyamide, polyamide with additives such as glass or metal particles, methyl methacrylate-acrylonitrile butadiene-styrene copolymer, resorbable materials such as polymer-ceramic composites, and other similar suitable materials. In some embodiments, commercially available materials may be utilized. These materials may include: DSM Somos® series of materials 7100, 8100, 9100, 9420, 10100, 11100, 12110, 14120 and 15100 from DSM Somos; ABSplus-P430, ABSi, ABS-ESD7, ABS-M30, ABS-M30i, PC-ABS, PC-ISO, PC, ULTEM 9085, PPSF and PPSU materials from Stratasys; Accura Plastic, DuraForm, CastForm, Laserform and VisiJet line of materials from 3-Systems; Aluminium, CobaltChrome and Stainless Steel materials; Maranging Steel; Nickel Alloy; Titanium; the PA line of materials, PrimeCast and PrimePart materials and Alumide and CarbonMide from EOS GmbH.

Custom footwear, including custom footwear portions, may be manufactured using additive manufacturing techniques. Advantageously, an additive manufacturing apparatus may “3D print” an entire footwear portion or an entire piece of footwear in a single, integral workpiece. For example, rather than manufacturing insoles, midsoles and outsoles separately, an additive manufacturing device may create a custom footwear portion layer-by-layer with nonhomogeneous corrective features (e.g. microstructures) in each individual layer. Thus, 3D printing may provide a much higher degree of customization of footwear as compared to traditional manufacturing techniques.

Further, 3D printing custom footwear may advantageously reduce the number of materials and individual pieces that need to be manufactured in order to arrive at a desired footwear design. Moreover, additive manufacturing techniques may take advantage of a wider range of materials for creating custom footwear as compared to traditional manufacturing techniques.

In some instances, additive manufacturing techniques may improve traditional manufacturing steps. For example, footwear portions may include surface textures, patterns, structures, etc., which may be useful for traditional manufacturing steps such as gluing, fusing, or otherwise fastening portions together. In some instances, the surface textures may be created by microstructures. As another example, an additively manufactured footwear portion may be finished with a manufacturing layer that has a high porosity and/or a particular texture in order to improve the joining of that portion with another footwear portion by glue or other fastening means.

### Description of Certain Exemplary Methods, Systems and Devices

Disclosed herein are methods for designing and manufacturing custom footwear or custom footwear portions. Any system or method described below is applicable both to the design of custom footwear and to the design of custom footwear portions. For the sake of efficiency, unless explicitly mentioned otherwise, the terms “custom footwear” or “custom footwear article” in the paragraphs below should be interpreted to cover one or more items of custom footwear, one or more custom footwear portions, or any combination thereof.

FIG. 11 shows an exemplary method 1100 comprising the following steps:
1. Acquiring footwear-specific data;
2. Acquiring user-specific data;
3. Generating a virtual model of a custom footwear article based on the acquired data; and
4. Manufacturing the custom footwear article based on the virtual model.

The article of custom footwear may be a custom footwear item or a custom footwear portion, or any part thereof. In the following description, the method will be elaborated with the example of a custom insole. However, a skilled person will readily appreciate that the present disclosure may apply to other custom footwear portions or to custom footwear items. For example, the method described below may be equally valid for the design and manufacturing of a custom outsole, a custom midsole or an entire custom sole. The described method can also be applied for the design and manufacture of a custom footwear item, such as a shoe, sandal, boot or sports shoe, comprising a custom insole, outsole, midsole or sole.

The method 1100 may be a computer-implemented method. The steps of this method may be performed by a computing device, with or without input from an operator.

In step 1110, footwear-specific data is acquired. The footwear-specific data may be any combination of one or more of the types of footwear-specific data as described above and may be acquired using any of the systems described above. Alternatively, the footwear-specific data may be loaded or imported from one or more files or from a database. In FIG. 11, step 1120 is depicted as following step 1110. However, it should be noted that, in certain embodiments, step 1110 is an optional step and that, in other embodiments, step 1120 may also be performed before step 1110.

In step 1120, user-specific data is acquired. The user-specific data may be any combination of one or more of the types of static or dynamic user-specific data as described above and may be acquired using any of the systems described above. Alternatively, the user-specific data may be loaded from one or more files or from a database.

In some embodiments, the user-specific data comprises dynamic user-specific data. The dynamic user-specific data may comprise pressure data acquired during a movement of the user, as described above. For example, a pressure-sensitive pad or mat may be used to measure the pressure distribution over one or both feet as it changes while the user walks or runs over it. From this measurement, at any time point during the stride, the center-of-pressure point (COP point) may be derived. As described above, this is the center of gravity of the total pressure exerted by the user's foot onto the pressure-sensitive pad or mat at that time point. In other words, this is the point in which a single force vector could balance the total pressure exerted by the user's foot at that time point. If the dynamic pressure measurement covers more than one stride, the pressure measurements of corresponding time points across multiple strides may be averaged. While walking or running, during each stride or roll-off, this COP point travels from an initial contact point to a push-off point. For certain users, it may travel from a posterior position—underneath the heel—to an anterior position—underneath the toes. For other users, who have a different gait, this COP point may exhibit a different trajectory, e.g., from the forefoot towards the midfoot and back to the forefoot. This trajectory is specific for the user and may indicate the presence of an undesirable condition.

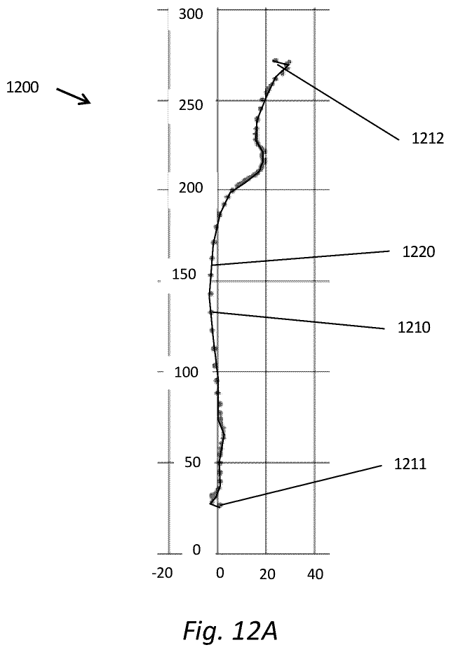

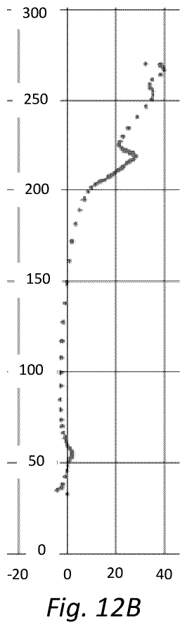

FIG. 12A shows a plot 1200 of the COP points 1210 at individual time points during a particular user's roll-off. The COP points 1210 are plotted in a two-dimensional co-ordinate system with the lateral-to-medial co-ordinate on the horizontal axis and the posterior-to-anterior co-ordinate on the vertical axis. The COP points 1210 follow a trajectory 1220, also referred to as the center-of-pressure curve (COP curve), from an initial COP point 1211, measured upon the landing, to a final COP point 1212, measured upon push-off. FIG. 12B shows a similar plot for a different user. As can be seen, here, the COP curve follows a more irregular trajectory.

In step 1130, a virtual model of a custom footwear article is generated based on the acquired user-specific data and—optionally—the acquired footwear-specific data. As mentioned above, the custom footwear article can be any custom item of footwear or custom footwear portion, such as a custom insole, custom midsole, custom outsole, custom sole or a custom item of footwear comprising a custom insole, custom midsole, custom outsole or custom sole. The virtual model may comprise a virtual three-dimensional model of any type known in the art, such as a CAD model, a surface model, such as a freeform surface model, a NURBS surface model, a surface mesh or a triangle mesh, a point cloud, a model comprising geometry precursors, such as described in WO2015/022341 A2, which is incorporated herein by reference in its entirety, or any combination of these. The virtual model may be stored in any appropriate data format, such as any known CAD format, VRML, STL, XML or TXT, in binary or ASCII-coded form.

The virtual model of the custom footwear article may comprise shape data representing any combination of footwear portions and subcomponents, layers and features of such footwear portions as described above. By way of example, Table 2 below provides a non-exhaustive list of combinations of footwear portions that may be comprised in a custom footwear article according to different embodiments of the present disclosure, wherein each column represents a different combination and an X in a column indicates that a certain footwear portion is present in the combination of that column.

TABLE 2

| | | | | | | | | | | | | | | | |
|---|---|---|---|---|---|---|---|---|---|---|---|---|---|---|---|
| Upper | | | | | | | | | | | | | | | |
| Outsole | X | | X | | X | | X | | X | | X | | X | | X |
| Midsole | | X | X | | | X | X | | | X | X | | | X | X |
| Fixed insole | | | | X | X | X | X | | | | | X | X | X | X |
| Removable | | | | | | | | X | X | X | X | X | X | X | X |
| insole | | | | | | | | | | | | | | | |
| Upper | X | X | X | X | X | X | X | X | X | X | X | X | X | X | X |
| Outsole | X | | X | | X | | X | | X | | X | | X | | X |
| Midsole | | X | X | | | X | X | | | X | X | | | X | X |
| Fixed insole | | | | X | X | X | X | | | | | X | X | X | X |
| Removable | | | | | | | | X | X | X | X | X | X | X | X |
| insole | | | | | | | | | | | | | | | |

Table 3 below provides a non-exhaustive list of combinations of footwear portions, subcomponents and layers that may be comprised in a custom footwear article according to different embodiments of the present disclosure when the custom footwear article is a custom insole, wherein each column represents a different combination and an X in a column indicates that a certain footwear portion, subcomponent or layer is present in the combination of that column.

| | | | | | | | | | | | | |
|---|---|---|---|---|---|---|---|---|---|---|---|---|
| Top layer | | | | | | | | | | | | |
| Base layer | X | X | X | X | X | X | X | X | X | X | X | X |
| Base layer: variable thickness layer | | X | | X | | X | | X | | X | | X |
| Base layer: directional stiffness layer | | | X | X | | | X | X | | | X | X |
| Base layer: stability layer | | | | | X | X | X | X | | | | |
| Base layer: reinforcement layer | | | | | | | | | X | X | X | X |
| Forefoot support | | | | | | | | | | | | |
| Top layer | | | | | | | | | | | | |
| Base layer | X | X | X | X | X | X | X | X | X | X | X | X |
| Base layer: variable thickness layer | | X | | X | | X | | X | | X | | X |
| Base layer: directional stiffness layer | | | X | X | | | X | X | | | X | X |
| Base layer: stability layer | X | X | X | X | | | | | X | X | X | X |
| Base layer: reinforcement layer | X | X | X | X | | | | | | | | |
| Forefoot support | | | | | X | X | X | X | X | X | X | X |
| Top layer | | | | | | | | | X | X | X | X |
| Base layer | X | X | X | X | X | X | X | X | X | X | X | X |
| Base layer: variable thickness layer | | X | | X | | X | | X | | X | | X |
| Base layer: directional stiffness layer | | | X | X | | | X | X | | | X | X |
| Base layer: stability layer | | | | | X | X | X | X | | | | |
| Base layer: reinforcement layer | X | X | X | X | X | X | X | X | | | | |
| Forefoot support | X | X | X | X | X | X | X | X | | | | |
| Top layer | X | X | X | X | X | X | X | X | X | X | X | X |
| Base layer | X | X | X | X | X | X | X | X | X | X | X | X |
| Base layer: variable thickness layer | | X | | X | | X | | X | | X | | X |
| Base layer: directional stiffness layer | | | X | X | | | X | X | | | X | X |
| Base layer: stability layer | X | X | X | X | | | | | X | X | X | X |
| Base layer: reinforcement layer | | | | | X | X | X | X | X | X | X | X |
| Forefoot support | | | | | | | | | | | | |
| Top layer | X | X | X | X | X | X | X | X | X | X | X | X |
| Base layer | X | X | X | X | X | X | X | X | X | X | X | X |
| Base layer: variable thickness layer | | X | | X | | X | | X | | X | | X |
| Base layer: directional stiffness layer | | | X | X | | | X | X | | | X | X |
| Base layer: stability layer | | | | | X | X | X | X | | | | |
| Base layer: reinforcement layer | | | | | | | | | X | X | X | X |
| Forefoot support | X | X | X | X | X | X | X | X | X | X | X | X |
| Top layer | | | | | | | | | X | X | X | X |
| Base layer | | | | | | | | | X | X | X | X |
| Base layer: variable thickness layer | | | | | | | | | | X | | X |
| Base layer: directional stiffness layer | | | | | | | | | | | X | X |
| Base layer: stability layer | | | | | | | | | X | X | X | X |
| Base layer: reinforcement layer | | | | | | | | | X | X | X | X |
| Forefoot support | | | | | | | | | X | X | X | X |

Generating the virtual model of the custom footwear article may comprise generating 3D shape data for some or all footwear portions, subcomponents, layers and features present in the custom footwear article. This can be done using general-purpose CAD software, or dedicated software that automates some or all of the process, such as dedicated software with a wizard-like structure that guides an operator through a predefined sequence of design operations. In some instances, the virtual model may represent only part of the custom footwear article. For example, in some embodiments, the custom footwear article may be a custom insole comprising a top layer and a base layer. The virtual model may in that case only comprise 3D shape data representative of the base layer. The top layer may then be added during the manufacturing step 1140, for example, from a sheet of compliant material. In some embodiments, the virtual model may comprise more than one three-dimensional model, e.g., for individual components that will be manufactured separately and then assembled. Additionally or alternatively, the virtual model may comprise one or more models having 2D shape data, for example, an outline of a footwear portion that is to be cut from a sheet of material.

In some embodiments, for example where the custom footwear article is an insole, the footwear-specific data acquired in step 1110 may be used in the design of certain parts of the virtual model. For example, in embodiments where the footwear-specific data comprises 3D shape data relating to one or more surfaces of an item of footwear, such as a shoe, in which the insole will be worn, such shape data can be used to generate the virtual model of the insole to have one or more contact surfaces that are complementary to at least part of one or more surfaces of the item of footwear, so as to improve the stability of the insole while it is worn in the item of footwear. This increased stability in turn improves the load transfer from the user's foot to the item of footwear and reduces the risk of sprains. In addition, providing an insole with one or more contact surfaces that are complementary to surfaces of the item of footwear may reduce the risk of the insole moving around inside the item of footwear, which is annoying for the user. The complementary contact surfaces may comprise one or more contiguous surfaces, a collection of linear contacts, a collection of point contacts or any combination of these. For example, the virtual model of an insole may comprise an underside, e.g. a side configured to face away from the user during use, that comprises one or more contiguous surfaces that are each complementary to at least a part of a surface of an item of footwear, such as a top surface of a midsole or of a fixed insole. Additionally or alternatively, the virtual model of an insole may comprise a three-dimensional texture on the underside, wherein the three-dimensional texture has one or more smaller surfaces, linear contacts and/or point contacts that are complementary to at least part of a surface of the item of footwear. Additionally or alternatively, the virtual model of an insole may comprise an ordered or unordered structure, for example, on its underside, for example as part of a stability layer as described above, such as can be seen in FIGS. 2A-2D. This ordered or unordered structure may fill a volume that is at least partly bound by an imaginary surface that is complementary to at least part of at least one surface of the item of footwear. As a result, the ordered or unordered structure may comprise a collection of linear contacts and/or point contacts that are complementary to at least part of a surface of the item of footwear. Additionally or alternatively, the virtual model of an insole may comprise a forefoot support as described above, with raised structures between the grooves and apertures, as can be seen in FIGS. 9A-9B and FIGS. 10A-10B. These raised structures may comprise a collection of surface contacts, linear contacts and/or point contacts that are complementary to at least part of at least one surface of the item of footwear.

In some embodiments, for example where the custom footwear article is a sole or an insole, the user-specific data acquired in step 1120 may additionally or alternatively be used in the design of certain parts of the virtual model. For example, in embodiments where the user-specific data comprises 3D shape data relating to a body part of a user, such as a foot, said 3D shape data, for example, acquired in any of the ways described, such as using an image-sensor-based system or a 3D scanner, such as a foot scanner, or partly or entirely derived from medical images, pressure measurements and/or statistical data, such 3D shape data can be used to generate the virtual model of the insole to have one or more contact surfaces that are complementary to at least part of one or more surfaces of the body part, so as to improve the user's comfort and the transfer of loads between the user's body part and the custom footwear article. The complementary contact surfaces may comprise one or more contiguous surfaces, a collection of linear contacts, a collection of point contacts or any combination of these. For example, the virtual model of an insole may have an upper side, e.g., the side configured to face the user during use, that comprises one or more contiguous surfaces that are each complementary to at least a part of a surface of a sole of the user's foot. In some embodiments, additional design operations may be performed on these one or more complementary surfaces. For example, a smoothing operation may be performed to remove any excessive protrusions. Additionally or alternatively, corrective features may be added to the virtual model of the insole, such as any one or more of the corrective features described above. Some of these corrective features, while not necessarily designed on top of the one or more complementary surfaces, may still deform the shape of the complementary surfaces to some extent, so as to modify the shape and weight distribution of the user's foot during the gait cycle. Additionally or alternatively, in those embodiments where the insole is designed to comprise a top layer, the thickness of this top layer may be taken into account when designing the top surface of a base layer. For example, when the top layer is to be manufactured from a sheet of material with a constant thickness, the top surface of the base layer may be designed as an offset at a fixed distance of the one or more complementary surfaces. The distance may be chosen equal to the thickness of the top layer, or smaller than the thickness of the top layer, so as to take compression of the top layer into account. In this example, the 2D outline of the top layer may additionally be determined and stored so as to allow the top layer to be cut during manufacturing step 1140 from a sheet of material. In some instances, particularly where certain user-specific data is missing or the available user-specific data is sparse, statistical body-part data may be used to generate “best-guess” 3D shape data representative of the user's body part to be used in the generation of the virtual model of the custom footwear article, using any of the techniques described above.

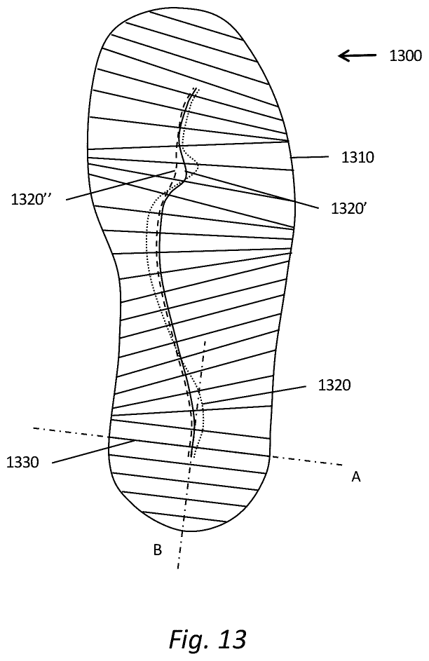

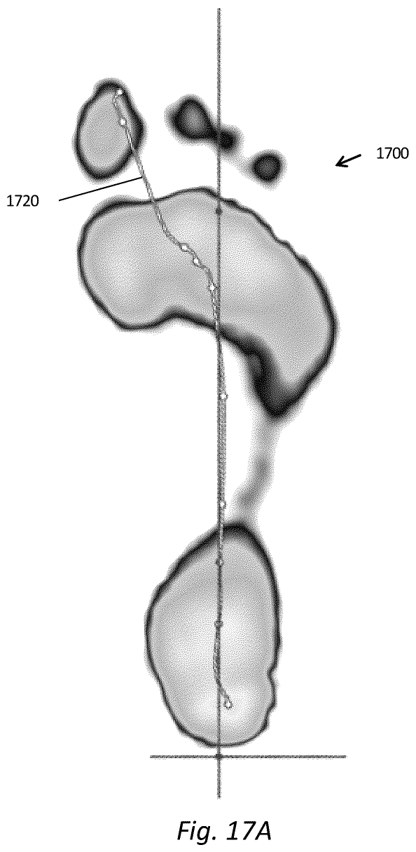

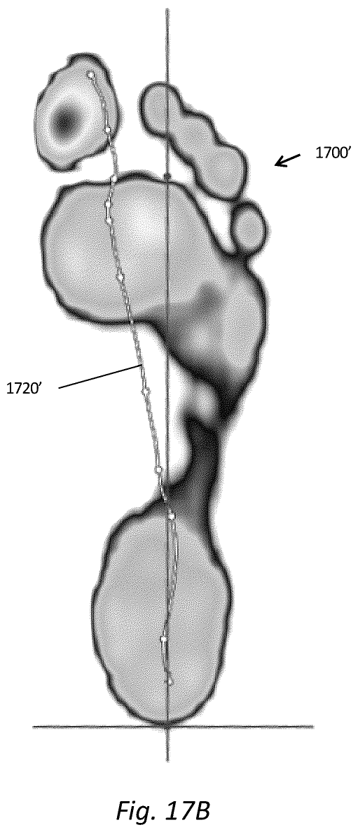

In some embodiments, where the acquired user-specific data comprises dynamic user-specific data and where a COP curve can be determined, this COP curve may be used in the design of the custom footwear article, for example, where the custom footwear article is a sole, an outsole or an insole. As described above, in some embodiments, the shape of the COP curve can be an indication of an adverse condition, of a risk of future pain or injuries or of a suboptimal gait or weight distribution. For example, FIG. 17A shows a pressure measurement 1700 for a particular user and the corresponding COP curve 1720 for the same user. COP curve 1720 exhibits a fairly usual shape. FIG. 17B shows a pressure measurement 1700′ for another user and the corresponding COP curve 1720′. COP curve 1720′ has a shape that indicates at pronation of the midfoot and forefoot, leading to an increased loading of the medial forefoot. This may imply an adverse condition, such as shin splints. A purpose of the custom footwear article may be to treat an adverse condition, to reduce the risk of future injuries or pain or to increase a performance by modifying the user's roll-off pattern and/or the weight distribution over a gait cycle. Such a modified roll-off pattern and/or the weight distribution may translate into a modified COP curve. In some embodiments, the custom footwear article may be designed according to a corrected, healthier target COP curve, for example, a target COP curve that is corrected based on statistical data characterizing users who do not suffer any adverse condition or who perform at a high level without injuries over long periods of time. The target COP curve may be based on the COP curve determined from dynamic user-specific data and may introduce in said user-specific COP curve certain targeted corrections, such as a smoothing of the curve, a straightening of the curve or a shifting of at least part of the curve towards the medial side, lateral side, or center. A custom footwear article, such as a sole, outsole or insole, may then be designed to comprise features, such as the corrective features described above, that stimulate the user's foot to move and roll according to a pattern that results in a COP curve that nears the target COP curve. For example, features may be designed to influence the directional stiffness of the custom footwear article so as to reference the target COP curve. In some embodiments, this may be achieved by, in each point along the target COP curve, making the custom footwear article more resistant to bending around an axis tangential to the target COP curve in that point than around an axis perpendicular to the direction of the target COP curve in that point. For example, directional stiffness features, such as bending lines, ribs, cuts, striations, waves, grooves, or other, as described above, may be designed in the virtual model of the custom footwear article. The directional stiffness features may be part of a distinguishable directional stiffness layer, as described above, or may be incorporated into another part or layer of the custom footwear article. For example, as is illustrated in FIG. 13, which shows the underside of a sole, outsole or insole 1300 with a contour 1310, designed for a user whose measured roll-off pattern results in a COP curve 1320 (dotted line). If the COP curve 1320 exhibits a healthy appearance, the directional stiffness features 1330 may be designed in the form of bending lines, ribs, cuts, striations, waves or grooves that are present on at least part of the underside of the custom footwear article 1300, i.e., the side facing away from the user, and that, in each point of the COP curve 1320, are substantially perpendicular to the COP curve 1320. Otherwise, the COP curve 1320 may be corrected by a computing system or an operator to target COP curve 1320′ (solid line). The directional stiffness features 1330 may then take the form of bending lines, ribs, cuts, striations, waves or grooves that, in each point of the target COP curve 1320′, are substantially perpendicular to the target COP curve 1320′. In locations where the COP curve 1320 or target COP curve 1320′, as the case may be, exhibits a small curvature radius or many irregularities, this may lead to aberrant patterns. These can be avoided by introducing an additional smoothing and/or straightening step on the COP curve 1320 or the target COP curve 1320′, respectively, to create a guide curve 1320″ (dashed line) and basing the design of the directional stiffness features 1330 on the guide curve 1320″ instead of the COP curve 1320 or the target COP curve 1320′. The directional stiffness features 1330 make the custom footwear article 1300 less resistant to bending around an axis A parallel to the bending lines, ribs, cuts, striations, waves or grooves than to bending around an axis B tangential to the COP curve 1320, the target COP curve 1320′ or the guide curve 1320″. In other embodiments, as illustrated in FIG. 14, the COP curve, target COP curve or guide curve 1420 may be used to deform the pattern of a surface texture 1430 that is applied to a surface, such as the underside, of a custom footwear article 1400, such as a sole, insole or outsole. Such a deformation may affect the surface texture in one, two or three dimensions. For example, in some instances, the surface texture may be deformed in the u and v coordinates, while in other instances, the surface texture may be deformed in the u, v and w coordinates, or only in the w coordinate, with the u and v coordinates being locally parallel to the surface on which the texture is applied, and the w coordinate being locally perpendicular to said surface. The deformation may be accomplished by applying a transformation on the u, v and w coordinates that affects one or more of the u, v and w coordinates and that is dependent on the shape of the COP curve, target COP curve or guide curve. Deforming a surface texture in u and v coordinates may result in the surface texture pattern being locally rotated and/or uniformly or non-uniformly scaled (e.g., stretched and/or compressed). Deforming a surface texture in the w coordinate may result in the surface texture pattern being locally higher or lower, in the case of an outdented texture (e.g., ribs laying on top of the surface), or deeper or shallower, in the case of an indented texture (e.g., grooves in the surface). Deforming a surface texture based on the COP curve, target COP curve or guide curve may help visualize the user's roll-off pattern to the user, to an operator, or to a trained professional, such as a podiatrist. Additionally, it may beneficially influence the mechanical behavior of the custom footwear article, such as its resistance to bending or its directional stiffness, in light of an adverse condition to be treated or avoided, or a performance to be increased by means of the custom footwear article. For example, as show, in FIG. 14, the deformation of the surface texture guides more material towards areas 1440, which sit on the concave side of curve 1420 and away from areas 1450, which sit on the convex side of curve 1420, in the case of an outdented surface texture (e.g., ribs laying on top of the surface), or, alternatively, more material towards areas 1450 and away from areas 1440 in the case of an indented surface texture (e.g., grooves in the surface). Additionally or alternatively, more material may be guided towards certain areas or away from certain areas by deforming the w coordinate as described above. In some instances, the height (for outdented textures) or depth (for indented textures) of a surface texture may vary locally from 0.1% to 35% of the thickness of the sole, outsole, insole or of the layer of such a sole, outsole or insole on which the texture is applied.

In some embodiments, the COP curve or the target COP curve may be made visible in the design of the custom footwear article. For example, in the case of a sole, outsole or insole, a groove, channel, rib or any visible break in the pattern, texture or tread following the shape of the COP curve or the target COP curve may be designed on a surface, such as the underside, of the custom footwear article. For example, area 1460 in FIG. 14 is a smooth area that represents a visible break in surface texture 1430 and follows the shape of COP curve or target COP curve 1420. As with the deformed surface texture described above, making the COP curve or target COP curve visible in the design of the custom footwear article may help visualize the user's roll-off pattern to the user, to an operator, or to a trained professional, such as a technician or a podiatrist.

In some instances, where the correction between the COP curve and the target COP curve is particularly big, the large discrepancy between the current roll-off pattern of the user's foot and the mechanical behavior of the custom footwear article, such as its directional stiffness, may initially lead to discomfort or pain. In such cases, it may be beneficial to design not one but a sequence of custom footwear articles, each based on one of a sequence of target COP curves. These may, for example, be consecutive interpolations between the current COP curve and a desired final target COP curve. Sequentially wearing each of these custom footwear articles for a limited period of time will give the user and the user's foot the opportunity to gradually adjust to each new roll-off pattern and the corresponding gait with minimal discomfort or pain, before moving to the next. Such a sequence of custom footwear articles may be manufactured one by one as the treatment progresses. This allows monitoring the effectiveness of the treatment and adjusting, should the need arise. Alternatively, all custom footwear articles of the sequence of custom footwear articles may be manufactured and/or delivered to the user at once. The period of time for wearing each of the sequence of custom footwear articles may be determined automatically, for example, based on the differences between consecutive target COP curves, or by a trained professional, such as a technician, foot expert or a podiatrist. Alternatively, it may be left to the user to decide when to switch to the next of the sequence of custom footwear articles. In instances where a sequence of custom footwear articles is designed, it may be beneficial to incorporate into the design an identifier to indicate the order in which the custom footwear articles should be worn by the user. For example, each individual custom footwear article may be labeled with a number indicating its rank and/or the date on which the user should start wearing it. The label may be an adhesive label attached to the custom footwear article, it may be printed onto a surface of the custom footwear article, or it may be designed as a surface relief, for example, indented into or outdented on top of a surface of the custom footwear article. Additionally or alternatively, it may be particularly useful to make the target COP curve on which the design of each of the sequence of custom footwear articles is based visible in the design, for example in any of the ways described above. This may help in identifying the order in which the custom footwear articles should be worn, and may help visualize to the user, to an operator or to a trained professional, such as a technician or a podiatrist, the envisaged gradual modification to the user's roll-off pattern.

The method then moves to optional step 1140, in which a custom footwear article is manufactured based, at least in part, on the virtual model generated in step 1130. The custom footwear article may be manufactured using any suitable combination of computer-aided manufacturing techniques and/or manual operations. For example, computer-aided cutting or milling machines may be used for cutting one or more components from a sheet or block of material. For example, as described above, the virtual model may comprise 2D shape data representing the outline of a top layer of a custom insole. The top layer may then be cut from a sheet of a suitable material based on said 2D outline. Additionally or alternatively, at least part of the custom footwear article may be manufactured used any of the additive-manufacturing techniques described above. Additive manufacturing techniques are particularly suited for the manufacturing of personalized objects, such as custom footwear articles, as opposed to more traditional manufacturing techniques, such as injection molding, which require at least part of the manufacturing machine, e.g., the mold, to be adapted for each new design of object. In addition, additive manufacturing techniques offer the advantages that no material is wasted, as opposed to, for example, milling, that objects with more complex geometries can be manufactured than with traditional manufacturing techniques, and that objects with many components, possibly with complex geometries, flexible hinges or even moving parts, may be manufactured as integral objects, obviating the need for assembly. In instances where individual components of the custom footwear article may be manufactured separately, possibly from different materials and/or using different manufacturing techniques, they may be automatically or manually assembled. For example, a soft top layer, for example, cut from a sheet of foam, rubber or leather, may be affixed (for example, using adhesive, glue, hook-and-loop fasteners, etc.) on top of a base layer manufactured using an additive manufacturing technique.

In those instance where, as described above, in step 1130 virtual models may be designed for a sequence of custom footwear articles, one, some or all of the custom footwear articles of the sequence may be manufactured simultaneously, sequentially or spread over time in step 1140.

Disclosed herein are systems for designing and manufacturing custom footwear or custom footwear portions. Any system or method described below is applicable both to the design of custom footwear and to the design of custom footwear portions. For the sake of efficiency, unless explicitly mentioned otherwise, the terms “custom footwear” or “custom footwear article” in the paragraphs below should be interpreted to cover one or more items of custom footwear, one or more custom footwear portions, or any combination thereof.

FIG. 15 depicts an embodiment of a custom-footwear system 1500. In the depicted embodiment, the custom-footwear system 1500 comprises a data-collection system 1510, a data-processing system 1520, a manufacturing system 1530, and a data store 1540. In some examples, any components that constitute the custom-footwear system 1500 may include any number of processors and/or memories, the processors that may be configured to perform one or more executable instructions on any device. Without limitation, the custom-footwear system 1500 may include fewer or additional modules or components that define the custom-footwear system 1500.

Data-collection system 1510 collects data regarding a particular user, such as information regarding a user's foot or feet and/or data regarding a particular item of footwear. Data-collection system 1510 may comprise a static-data-collection module 1512 configured to acquire static user-specific data, a dynamic-data-collection module 1514 configured to acquire dynamic user-specific data and/or a footwear-data-collection module 1516 configured to acquire footwear-specific data. In some embodiments, data-collection system 1510 may be configured to perform or may be used by an operator to perform steps 1110 and/or 1120 of the method described above.

In some embodiments, data-collection system 1510 may comprise one or more devices configured to acquire, measure, or collect various types of user-specific and/or footwear-specific data, such as pressure-sensitive mats or pads, image-sensor-based systems, mechanical scanning systems, 2D or 3D optical scanners, laser-based scanners, cavity scanners or any other of the devices described above.

In some embodiments, data-collection system 1510 may be portable and independent of other elements of custom-footwear system 1500, while in other embodiments it may be integral. Data-collection system 1510 may include sensors (e.g. pressure-sensitive pads and cameras, or any combination of the sensors or data-acquisition devices mentioned above) as well as processing devices that may be configured to support those sensors (e.g. mobile devices, computers, servers, and the like).

Data-collection system 1510 may comprise local data stores (not shown) and/or connections to remote data stores, such as data store 1540. Data collected by data-collection system 1510 may be stored in local or remote data stores (or both) after being sensed, measured, determined, entered, uploaded or otherwise created.

Data-collection system 1510 may be in data communication with other elements of custom-footwear system 1500 via, for example, hard-wired or wireless data connections. For example, in embodiments where data-collection system 1510 is portable and independent of other elements of custom-footwear system 1500, data-collection system 1510 may be configured to connect to those elements and share data via a network connection, such as the Internet. In other embodiments, the connection may instead be ad-hoc between various elements.

Data-processing system 1520 is in data communication with data-collection system 1510. Data-processing system 1520 may be configured to receive static and/or dynamic user-specific data and/or footwear-specific data collected by data-collection system 1510 and use that data in the design of custom footwear. Data-processing system 1520 may comprise local data stores (not shown) and/or connections to remote data stores, such as data store 1540. Data-processing system 1520 may be configured to receive from such data store statistical body-part data and use that data in the design of custom footwear. Data-processing system 1520 may comprise general-purpose CAD software, or dedicated software that automates some or all of the process, such as dedicated software with a wizard-like structure that guides an operator through a predefined sequence of design operations. In some embodiments, data-processing system 1520 may be configured to perform or may be used by an operator to perform step 1130 of the method described above.

In some embodiments, data-processing system 1520 is portable and independent of other elements of custom-footwear system 1500, while in other embodiments it may be integral. For example, data-processing system 1520 may be a computer system, such as a laptop computer, which is portable. In other embodiments, data-processing system 1520 may be remote from other elements of custom-footwear system 1500. For example, data-processing system 1520 may be a remote server that may be configured to receive data over data links and process that data remotely.

As describe above, data-processing system 1520 may comprise local data stores (not shown) and/or connections to remote data stores, such as data store 1540. The output of data-processing system 1520 (e.g. a virtual model of a custom footwear article) may be stored in data store 140.

Data-processing system 1520 may be in data communication with other elements of custom-footwear system 1500 via, for example, hard-wired or wireless data connections. For example, in embodiments where data-processing system 1520 is portable and independent of other elements of custom-footwear system 1500, data-processing system 1520 may be configured to connect to those elements and share data via a network connection such as the Internet. In other embodiments, the connection may instead be ad-hoc between various elements.

Manufacturing system 1530 may comprise a controller 1532 and an additive manufacturing device 1534. Manufacturing system 1530 may receive data from data-processing system 1520 in order to manufacture custom footwear or custom footwear portions, such as insoles, midsoles, and outsoles. For example, manufacturing system 1530 may receive custom footwear design data in the form of “STL” or “PLY” formatted files from data-processing system 1520, which may be interpreted by the controller 1532 in order to drive the additive manufacturing device 1534. In some embodiments, manufacturing system 1530 performs or may be used by an operator to perform step 1140 of the method described above.

It should be noted that the lines of data communication depicted between data-collection system 1510, data-processing system 1520, manufacturing system 1530, and data store 1540 in FIG. 15 are representative only. The data communication paths between the various elements of custom-footwear system 1500 may be direct or indirect, may traverse a single or multiple networks, may include intervening devices, may be wired or wireless, may use different protocols, may use different mediums, etc. Moreover, the data communication paths may be one-way or two-way such that data may be shared between various elements.

In some embodiments, the elements of custom-footwear system 1500 depicted in FIG. 15 may be integrated into a single system. In such embodiments, a user may be able to be scanned (e.g. using image sensors) and tested (e.g. using pressure sensitive pads) and subsequently receive custom footwear or custom footwear portions, such as a body, an insole, a midsole, or an outsole, all in the same place. In such embodiments, an operator may be present to take part in or at least validate the design of the custom footwear. However, in other embodiments, the entire process may be automated. For example, in some embodiments, the entire custom-footwear system 1500 may be a kiosk or the like at a footwear store, sporting goods store, or any other type of store.

In other embodiments, the elements of custom-footwear system 1500 may be separate. For example, the data-collection system 1510 may be separate from the data-processing system 1520 and the manufacturing system 1530 (though the latter two systems may be integral or co-located). For example, a kiosk or the like may include a data-collection system comprising various sensors, such as image sensors and pressure sensitive pads, which may be in data communication with a data-processing system 1520 and manufacturing system 1530 in another location. Notably, while these various elements may be physically separate in certain embodiments, they may still be co-located at a particular location, such as a footwear store in order that a user could be scanned and provided with custom footwear at the same location.

In yet other embodiments, the data-collection system 1510 and the manufacturing system 1530 may be co-located, while the data-processing system 1520 may be in a separate location. Due to the complex processing performed by the data-processing system 1520, it may be desirable to locate the data-processing system 1520 apart from the data-collection system 1510 and the manufacturing system, such as in a remote server location. For example, a footwear store may have the data-collection system 1510 and manufacturing system 1530 in the same location, while the data-processing system (and potentially its operator) may be located in a completely different location. In this way, sellers of custom footwear could limit the cost and space associated with every element and only have those elements of the custom-footwear system 1500 that are most convenient to users. Such embodiments would also allow purveyors of custom footwear systems to utilize different equipment distribution and sales models. For example, a custom-footwear system purveyor could sell certain elements of the system, such as the data collection system, while offering a subscription model to other elements, such as the data processing system. Ultimately, the custom-footwear system 1500 may be integral or modular, such as for a particular end-user of the system.

Disclosed herein are custom footwear articles as they may be designed and/or manufactured using any of the methods and/or systems described herein. The custom footwear articles may be any item of footwear or any footwear portion described herein and may comprise any combination of footwear portions or features described herein. In particular, the custom footwear articles may comprise any of the combinations of footwear portions or features listed in Tables 1-3.

In some embodiments, the custom footwear articles disclosed herein are soles, outsoles or insoles of which the design is based directly or indirectly on the user's COP curve. For example, the custom footwear articles may comprise directional stiffness features or a surface pattern of which the design is based on the user's COP curve, on a target COP curve or on a guide curve as described above. Additionally or alternatively, the user's COP curve or a target COP curve may be visible in the design of the custom footwear article, as described above.

What is claimed is:

1. A footwear article comprising:
at least a portion of one or more of a sole, an insole, a midsole, an outsole, or an upper; and
at least one corrective feature configured to stimulate a foot of a user to move and roll in accordance with a pattern based on a target center of pressure (COP) curve, wherein the at least the portion of the one or more of the sole, the insole, the midsole, the outsole, or the upper comprises the at least one corrective feature.

2. The footwear article of claim 1, wherein the footwear article comprises a visible contour, in a surface texture of the footwear article, that follows a shape of a center of pressure curve or the target center of pressure curve.

3. The footwear article of claim 1, wherein the at least one corrective feature comprises:
a surface texture at least partially on at least one surface of the footwear article.

4. The footwear article of claim 3, wherein the surface texture comprises a surface texture pattern configured to be deformed along one or more coordinates based on the target COP curve or another COP curve.

5. The footwear article of claim 1, wherein the at least one corrective feature comprises:
a directional-stiffness layer that includes one or more of a series of bending lines, ribs, cuts, striations, waves, grooves, or other patterns.

6. The footwear article of claim 1, further comprising:
a stability layer configured to flex or flatten in different regions.

7. The footwear article of claim 1, further comprising:
a forefoot support.

8. The footwear article of claim 1, wherein the at least one corrective feature is selected from: one or more bending lines, ribs, cuts, striations, waves, or grooves.

9. The footwear article of claim 1, further comprising:
a groove, channel, rib, or visible break in a pattern, texture or tread of the footwear article that follows the shape of the target COP curve or another COP curve.

10. The footwear article of claim 1, wherein the footwear article is configured to be less resistant to bending around an axis tangential to the target COP curve than around an axis perpendicular to a direction of the target COP curve.

11. The footwear article of claim 1, wherein the footwear article comprises the insole.

12. A method for manufacturing a footwear article, the method comprising the steps of:
a) acquiring footwear-specific data;
b) acquiring user-specific data;
c) generating a model of the footwear article based on the acquired footwear-specific data, the user-specific data, and a plurality of user-specific two-dimensional or three-dimensional body-part data from a training set, the training set comprising a plurality of members of a population; and
d) manufacturing the footwear article based on the model.

13. The method according to claim 12, wherein at step b), the user-specific data comprises comprising pressure data and a center of pressure point, and step d) comprises manufacturing the footwear article with at least one corrective feature that is configured to stimulate a foot of a user to move and roll in accordance with a pattern based on a target center of pressure curve.

14. The method according to claim 13, wherein at step b), the user-specific data comprises dynamic user-specific data, and at step d) the target center of pressure curve is based on the dynamic user-specific data.

15. The method of claim 12, wherein generating the model comprises:
constructing a statistical model based on the plurality of user-specific two-dimensional or three-dimensional body-part data from the training set.

16. The method of claim 15, wherein the statistical model comprises a statistical shape model (SSM).

17. The method of claim 15, wherein generating the model comprises fitting the statistical model to the user-specific data.

18. The method of claim 17, wherein fitting the statistical model to the user-specific data comprises:
fitting a three-dimensional statistical model of a user foot to a two-dimensional outline of the user foot.

19. The method of claim 17, wherein fitting the statistical model to the user-specific data comprises:
determining one or more coefficient values of the statistical model.

20. The method of claim 15, wherein acquiring the user-specific data comprises automatically analyzing image data using the statistical model.
